(19) United States
(12) Patent Application Publication
(10) Pub. No.: US 2026/0067473 A1
(43) Pub. Date: Mar. 5, 2026

(54) ENCODING AND DECODING METHODS USING TEMPLATE-BASED TOOL AND CORRESPONDING APPARATUSES

(71) Applicant: InterDigital CE Patent Holdings, SAS, Paris (FR)

(72) Inventors: Thierry Dumas, Rennes (FR); Franck Galpin, Thorigne-Fouillard (FR); Philippe Bordes, Laille (FR); Kevin Reuze, Rennes (FR)

(21) Appl. No.: 19/109,808

(22) PCT Filed: Aug. 31, 2023
(86) PCT No.: PCT/EP2023/073959

§ 371 Date: Mar. 7, 2025

(30) Foreign Application Priority Data
Sep. 7, 2022 (EP) 22306323.1

(51) Int. Cl. H04N 19/189; H04N 19/176; H04N 19/182

(52) U.S. Cl. CPC H04N 19/189; H04N 19/176; H04N 19/182

(57) ABSTRACT

A decoding method is disclosed. Information for identifying which pixels (e.g. decoded pixels) are unavailable inside a template of a current block of a picture is obtained. A template-based tool is further applied using the obtained information to determine information to be used for decoding the current block. Finally, the current block is decoded using the determined information.

### CROSS REFERENCE TO RELATED APPLICATIONS

This application claims the benefit of European Application No. 22306323.1, filed on Sep. 7, 2022, which is incorporated herein by reference in its entirety.

### TECHNICAL FIELD

At least one of the present embodiments generally relates to a method and an apparatus for encoding and decoding a picture block using an output of a template-based tool.

### BACKGROUND

To achieve high compression efficiency, image and video coding schemes usually employ prediction and transform to leverage spatial and temporal redundancy in the video content. Generally, intra or inter prediction is used to exploit the intra or inter picture correlation, then the differences between the original block and the predicted block, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY

In one embodiment, a decoding method is disclosed that comprises:
obtaining information for identifying which pixels (e.g. decoded pixels) pixels are unavailable inside a template of a current block of a picture;
applying a template-based tool using the obtained information to determine information to be used for decoding the current block; and
decoding said current block using said determined information.

A decoding apparatus is disclosed that comprises one or more processors and at least one memory coupled to said one or more processors, wherein said one or more processors are configured to perform the method disclosed above.

In another embodiment, an encoding method is disclosed that comprises:
obtaining information for identifying which pixels (e.g. decoded pixels) are unavailable inside a template of a current block of a picture;
applying a template-based tool using the obtained information to determine information to be used for encoding the current block; and
encoding said current block using said determined information.

An encoding apparatus is disclosed that comprises one or more processors and at least one memory coupled to said one or more processors, wherein said one or more processors are configured to perform the method disclosed just above.

Further embodiments that can be used alone or in combination are described herein.

One or more embodiments also provide a computer program comprising instructions which when executed by one or more processors cause the one or more processors to perform the method for predicting chroma samples or encoding/decoding image or video data according to any of the embodiments described herein. One or more of the present embodiments also provide a non-transitory computer readable medium and/or a computer readable storage medium having stored thereon instructions for predicting chroma samples or encoding/decoding image or video data according to the methods described herein.

One or more embodiments also provide a computer readable storage medium having stored thereon a bitstream generated according to the methods described herein. One or more embodiments also provide a method and apparatus for transmitting or receiving the bitstream generated according to the methods described above.

### BRIEF DESCRIPTION OF THE DRAWINGS

FIG. 1 illustrates a block diagram of a system within which aspects of the present embodiments may be implemented;

FIG. 2 illustrates a block diagram of an embodiment of a video encoder;

FIG. 3 illustrates a block diagram of an embodiment of a video decoder;

FIGS. 4A, 4B, and 4C illustrate incrementation of a HOG bin from the horizontal gradient G_{HOR} and the vertical gradient G_{VER} computed at a given decoded reference sample in the middle row or the middle column of the template of the current W×H luminance CB to be encoded/decoded;

FIG. 5 illustrates input to the spatial 5-tap component of the filter when CCCM predicts the current chrominance CB to be encoded/decoded from the potentially downsampled version of the reconstructed luminance CB that is collocated with the current chrominance CB;

FIGS. 6A, 6B, 6C illustrate the current W×H chrominance CB (201) to be encoded/decoded, its chrominance reference area (203), the downsampled reconstructed luminance CB (200) that is collocated with this chrominance CB, and the luminance reference area (202) in the case of chroma format 4:2:0;

FIG. 7 illustrates a search for the candidate reconstructed W×H luminance block (302) belonging to the search range of TMP whose template (303) is the closest to the template (301) of the current W×H luminance CB to be encoded/decoded (300) in terms of SAD;

FIG. 8A illustrates the identification of the reference (in terms of motion) samples of the template T of the current block to be encoded/decoded in the case of a bi-directional merge candidate;

FIG. 8B illustrates the identification of the reference (in terms of motion) samples of each sub-template in the template T of the current block to be encoded/decoded in the case of a subblock-based merge candidate;

FIG. 9A illustrates prediction of a current 4×4 luminance CB via the MIP mode of index k 531 [[0, 15]];

FIG. 9B illustrates prediction of a current 8×4 luminance CB via the MIP mode of index k 531 [[0, 7]];

FIGS. 9C and 9D illustrate mapping from the index of the MIP mode to the index of the MIP matrix for a current 4×4 luminance CB and a current 8×4 luminance CB respectively;

FIGS. 10A and 10B illustrate two templates (311) (314) of a given W×H block (310), fed into typical template-based neural networks without translation equivariance;

FIG. 11 illustrates a method for encoding a block using a template-based tool according to an embodiment;

FIG. 12 illustrates a method for decoding a block using a template-based tool according to an embodiment; and

FIGS. 13A-26D illustrate various embodiment of the encoding/decoding methods.

### DETAILED DESCRIPTION

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

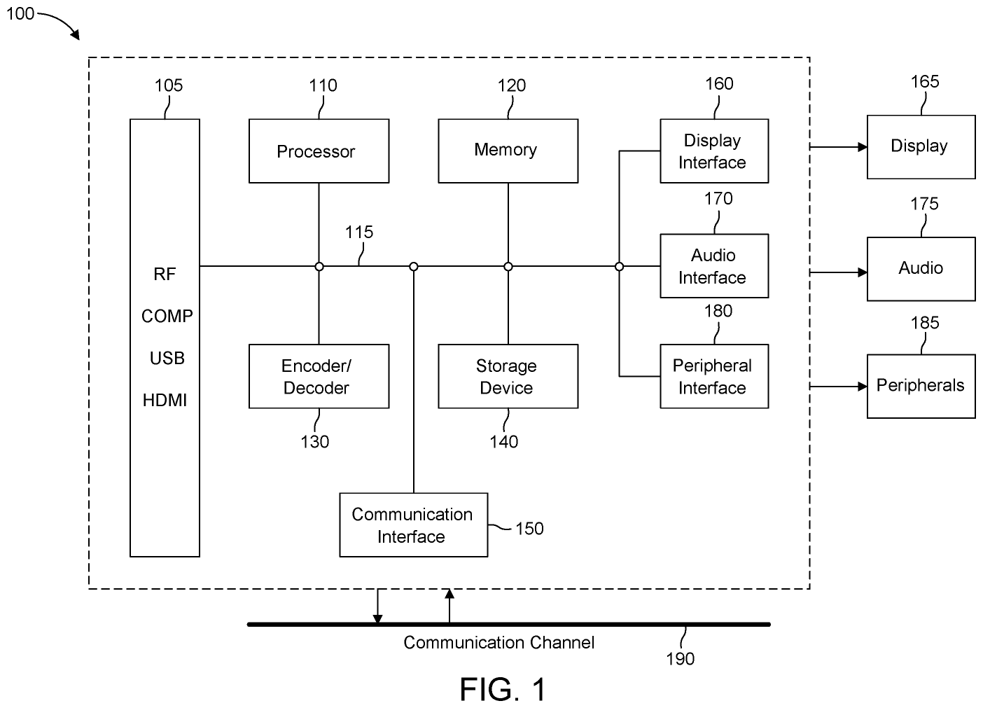

The aspects described and contemplated in this application can be implemented in many different forms. FIGS. 1, 2 and 3 below provide some embodiments, but other embodiments are contemplated and the discussion of FIGS. 1, 2 and 3 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “encoded” or “coded” may be used interchangeably, the terms “pixel” and “sample” may be used interchangeably and the terms “image,” “picture” and “frame” may be used interchangeably. Usually, but not necessarily, the term “reconstructed” is used at the encoder side while “decoded” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

The present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In some embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 100 may be provided through various input devices as indicated in block 105. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11 (IEEE refers to the Institute of Electrical and Electronics Engineers). The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105. As indicated above, various embodiments provide data in a non-streaming manner. Additionally, various embodiments use wireless networks other than Wi-Fi, for example a cellular network or a Bluetooth network.

The system 100 may provide an output signal to various output devices, including a display 165, speakers 175, and other peripheral devices 185. The display 165 of various embodiments includes one or more of, for example, a touchscreen display, an organic light-emitting diode (OLED) display, a curved display, and/or a foldable display. The display 165 can be for a television, a tablet, a laptop, a cell phone (mobile phone), or other device. The display 165 can also be integrated with other components (for example, as in a smart phone), or separate (for example, an external monitor for a laptop). The other peripheral devices 185 include, in various examples of embodiments, one or more of a stand-alone digital video disc (or digital versatile disc) (DVR, for both terms), a disk player, a stereo system, and/or a lighting system. Various embodiments use one or more peripheral devices 185 that provide a function based on the output of the system 100. For example, a disk player performs the function of playing the output of the system 100.

In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

The embodiments can be carried out by computer software implemented by the processor 110 or by hardware, or by a combination of hardware and software. As a non-limiting example, the embodiments can be implemented by one or more integrated circuits. The memory 120 can be of any type appropriate to the technical environment and can be implemented using any appropriate data storage technology, such as optical memory devices, magnetic memory devices, semiconductor-based memory devices, fixed memory, and removable memory, as non-limiting examples. The processor 110 can be of any type appropriate to the technical environment, and can encompass one or more of microprocessors, general purpose computers, special purpose computers, and processors based on a multi-core architecture, as non-limiting examples.

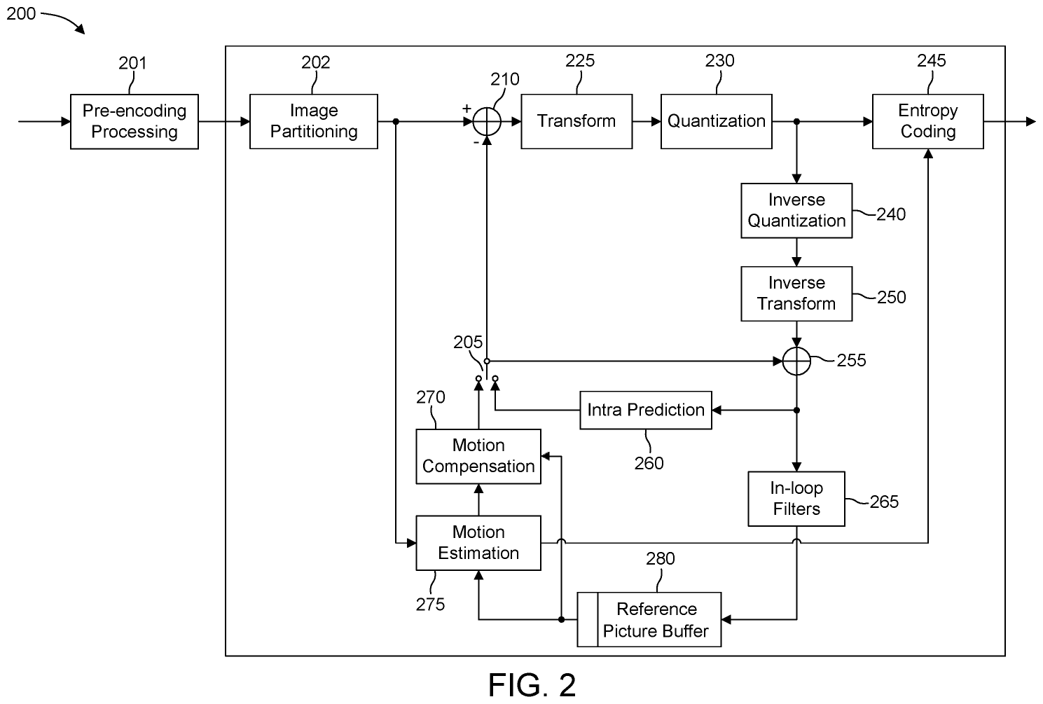

FIG. 2 illustrates an example video encoder 200, such as a VVC (Versatile Video Coding) encoder. FIG. 2 may also illustrate an encoder in which improvements are made to the VVC standard or an encoder employing technologies similar to VVC.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 200, a picture is encoded by the encoder elements as described below. The picture to be encoded is partitioned (202) and processed in units of, for example, CUs (Coding Units). Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements such as the picture partitioning information, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset)/ALF (Adaptive Loop Filter) filtering to reduce encoding artifacts. The filtered image is stored in a reference picture buffer (280).

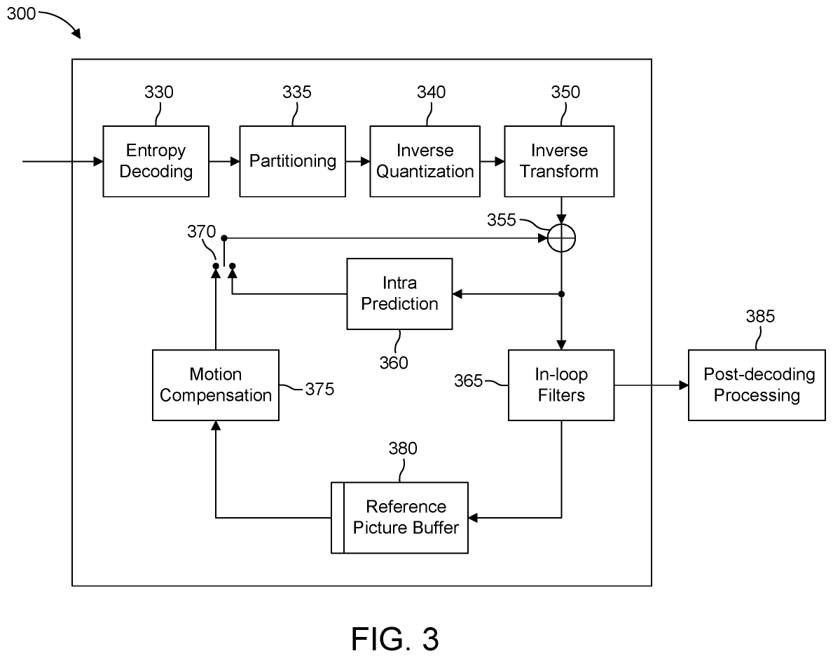

FIG. 3 illustrates a block diagram of an example video decoder 300. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, prediction modes, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block can be obtained (370) from intra prediction (360) or motion-compensated prediction (i.e., inter prediction) (375). In-loop filters (365) are applied to the reconstructed image. The filtered image is stored at a reference picture buffer (380). Note that, for a given picture, the contents of the reference picture buffer 380 on the decoder 300 side is identical to the contents of the reference picture buffer 280 on the encoder 200 side for the same picture.

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

In the follows, some template-based tools in ECM (Enhanced Compression Model) are detailed. The template-based tool is configured to output information to be used for encoding a block of a picture. This information may be of various types such as a prediction of the block to be encoded, one or more prediction modes for the block to be encoded, one or more transforms to be used with the block to be encoded, a reordered list of merge candidates to be used for the block to be encoded, etc. This list is not exhaustive, and the present embodiments are neither limited to a specific template-based tool nor to a specific type of output information.

### Decoder-Side Intra Mode Derivation (DIMD)

In ECM-4.0, DIMD derives, from the gradients in a template of decoded reference samples of the current luminance coding block (CB) to be encoded/decoded, the indices of two intra prediction modes that are likely the two best intra prediction modes for predicting the current luminance CB in terms of rate-distortion. Later, the current luminance CB is predicted by blending the two predicted blocks obtained by applying the two derived intra prediction modes with the predicted block obtained by applying PLANAR which is one of intra prediction mode defined in VVC. The weights involved in the blending are derived from the gradients in this template.

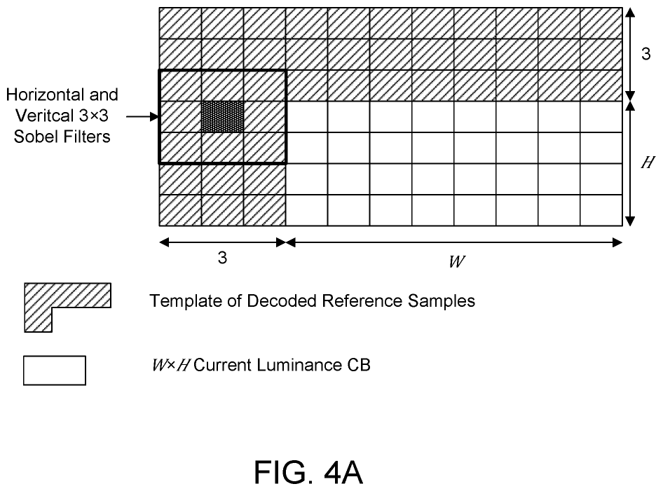

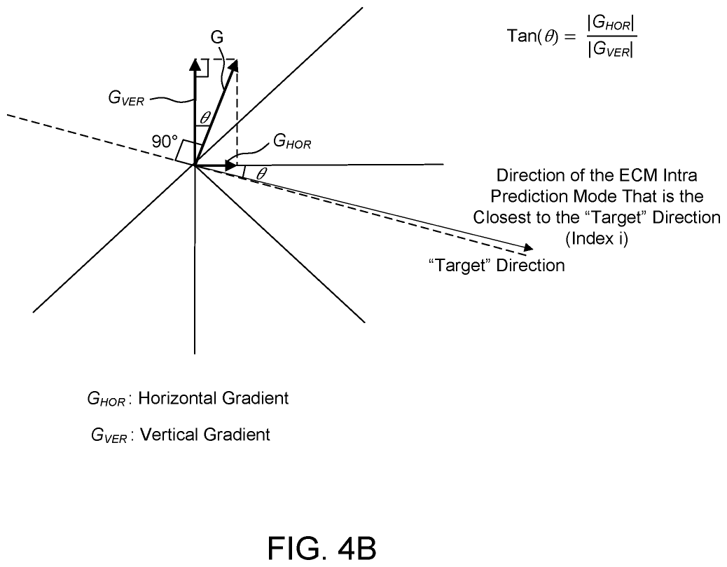

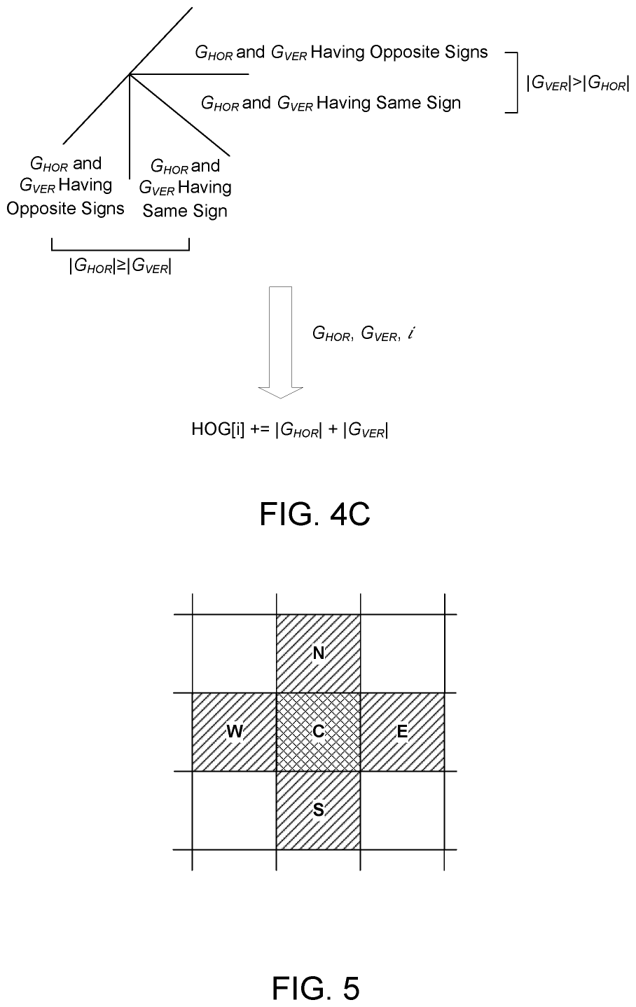

More specifically, for the current luminance CB, the indices of the two intra prediction modes are derived from the gradients in this template as depicted in FIGS. 4A, 4B and 4C. First, a Histogram of Oriented Gradients (HOG) with 65 bins, corresponding to the 65 directional intra prediction modes, is initialized to 0. Then, for each decoded reference sample in the middle row or the middle column of the template of three rows of decoded reference samples above the current luminance CB and three columns of decoded reference samples on its left side, the following procedure applies.

A 3×3 horizontal Sobel filter and a 3×3 vertical Sobel filter, both centered at this decoded reference sample, as shown in FIG. 4A, yield a horizontal gradient G_{HOR} and a vertical gradient G_{VER} respectively.

The signs of G_{HOR} and G_{VER} indicate in which of the four ranges of directions is found the “target” direction being perpendicular to the gradient G of horizontal component G_{HOR} and vertical component G_{VER}, as illustrated in FIG. 4C. If |G_{VER}|>|G_{HOR}|, the anchor direction corresponds to the horizontal direction. If |G_{HOR}|≥|G_{VER}, the anchor direction corresponds to the vertical direction. The “target” direction forms an angle θ with respect to the anchor direction, as shown in FIG. 4B.

By discretizing a scaled version of tan(θ), the index i of the ECM directional intra prediction mode whose direction is the closest to the “target” direction is found.

The HOG bin of index i is incremented by |G_{HOR}|+|G_{VER}|, as shown in FIG. 4C.

Finally, the indices of the two largest HOG bins are the indices of the two derived intra prediction modes.

Note that, in the above procedure, the fact that the “target” direction is perpendicular to the gradient G is justified by the following principle: when a directional intra prediction mode extrapolates reference samples into a given area along a direction [symbol] , the prevailing gradient in this area will most likely be perpendicular to [symbol] .

### Convolutional Cross-Component Model (CCCM)

In the Exploration Experiment (EE) on top of ECM-4.0, the Convolutional Cross-Component Model (CCCM) predicts the current chrominance CB to be encoded/decoded by applying a convolutional filter to the potentially downsampled version of the reconstructed luminance CB that is collocated with the current chrominance CB. When using chroma sub-sampling, this downsampling is carried out such that the resolution of the downsampled collocated reconstructed luminance CB matches the resolution of the chroma grid.

The CCCM convolutional 7-tap filter consists of a 5-tap plus sign shape spatial component, a nonlinear term, and a bias term. The input to the spatial 5-tap component of the filter consists of a center (C) luma sample that is collocated with the current chroma sample to be predicted and its above/north (N), below/south (S), left/west (W), and right/east (E) neighbors, as shown in FIG. 5.

The nonlinear term P is represented as power of two of the center luma sample C and scaled to the sample value range of the content

$$P = ( C * C + midVal ) ≫ bitDepth$$

where bitDepth represents the pixel bit depth, and midVal represents the middle value of the bit depth range.

For instance, for 10-bit content, it is calculated as

$$P = ( C * C + 512 ) ≫ 10.$$

The bias term B represents a scalar offset between the input and output. B is set to middle chroma value, e.g., 512 for 10-bit content.

Calling c0, c1, c2, c3, c4, c5, and c6 the seven coefficients of the 7-tap filter, the current predicted chroma sample “predChromaVal” is expressed as:

$$predChromaVal = clip ( {c}_{0} C + {c}_{1} N + {c}_{2} S + E + {c}_{4} W + {c}_{5} P + {c}_{6} B )$$

where “clip” clips to the range of valid chroma sample values.

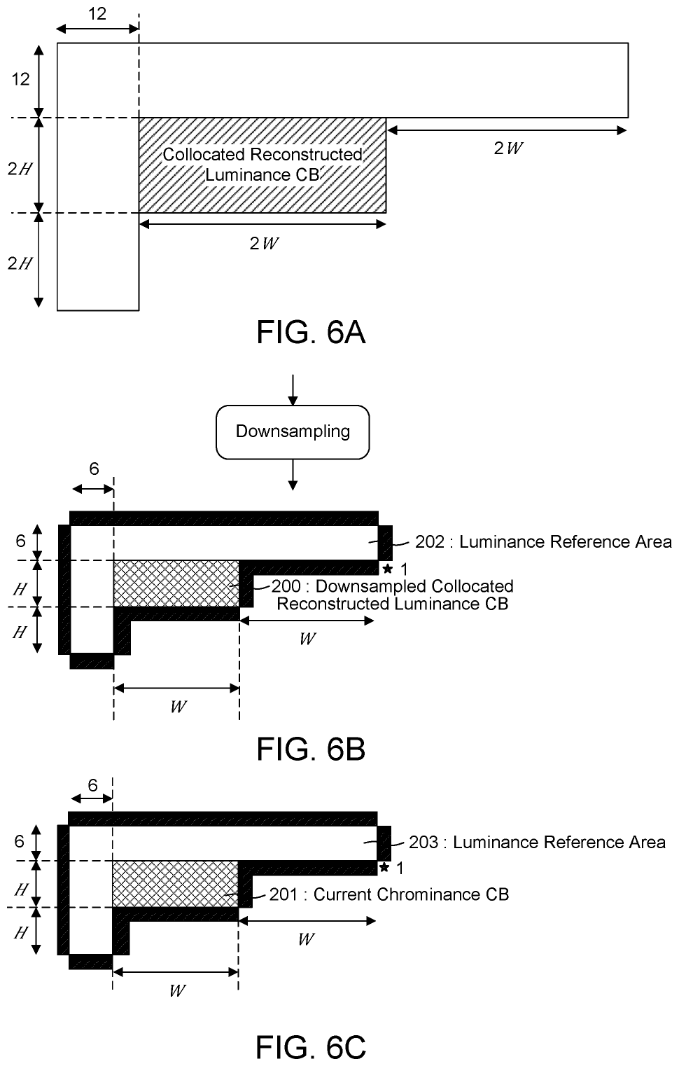

The filter coefficients c₀, c₁, c₂, c₃, c₄, c₅, and c₆ are calculated by minimizing the Mean Squared Error (MSE) between the predicted chroma samples generated by applying the convolutional 7-tap filter to the potentially downsampled version of the reconstructed luma samples in the luminance reference area (202) and the reconstructed chroma samples in the chrominance reference area (203) as shown in FIG. 6A, FIG. 6B and FIG. 6C.

FIG. 6A illustrates the reconstructed luminance CB that is collocated with the current W×H chrominance CB (201) to be encoded/decoded. FIG. 6B illustrates the downsampled reconstructed luminance CB (200) that is collocated with this chrominance CB, and the luminance reference area (202) in the case of chroma format 4:2:0, i.e., before encoding, the resolution of each chrominance channel is divided by 2 via sub-sampling. FIG. 6C illustrates its chrominance reference area (203).

The luminance reference area (202) consists of six rows/columns of potentially downsampled reconstructed luma samples above and on the left side of the potentially downsampled version of the reconstructed luminance CB (200) that is collocated with the current chrominance CB. The chrominance reference area (203) consists of six rows/columns of reconstructed chroma samples above and on the left side of the current chrominance CB (201) to be encoded/decoded. Each reference area extends one CB width to the right and one CB height below the CB boundaries. Each reference area is adjusted to include only available decoded reference samples. The extensions to the areas, filled in black in FIGS. 6B and 6C, are needed to support the side samples of the plus shaped spatial filter and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows the calculation of the Adaptive Linear Filtering (ALF) filter coefficients in ECM, except that LDL decomposition is chosen instead of Cholesky decomposition to avoid using square root operations. The calculation uses only integer arithmetic.

Note that a single model or multi-model variant of CCCM can be used. The multi-model variant uses two models, one model derived for samples above the average luma reference value and another model for the rest of the samples. Multi-model CCCM mode can be selected for Coding Units (CUs) containing at least 128 available decoded reference samples.

Note also that the term “reference area” has been chosen to match the standard nomenclature of CCCM. But a reference area of a given CB is equivalent to the template of this CB.

### Template Matching Prediction (TMP)

In ECM-4.0, Template Matching Prediction (TMP) is an intra prediction mode that predicts the current W×H luminance CB to be encoded/decoded.

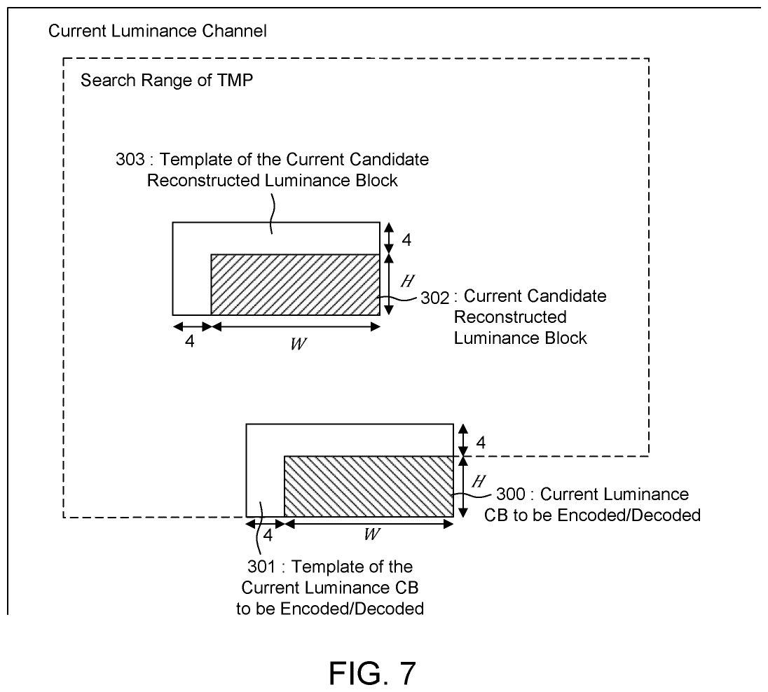

To this aim, the template (301) of the current luminance CB (300) is made of 4 rows of decoded reference samples above the current luminance CB and 4 columns of decoded reference samples on its left side, as shown in FIG. 7. In a search step, for each allowed position in given search range of TMP in the current luminance channel, the candidate reconstructed W×H luminance block (302) whose top-left pixel is positioned at this allowed position is considered, and the Sum of Absolute Differences (SAD) between its template (303) of 4 rows of decoded reference samples above it and 4 columns of decoded reference samples on its left side and the template (301) of the current luminance CB (300) is computed. The selected reconstructed luminance block (best candidate) is the one with minimum template matching SAD.

The selected candidate reconstructed luminance block is then used to predict the current luminance CB.

Adaptive Reordering of Merge Candidates with Template Matching (ARMC-TM)

In ECM-4.0, merge candidates are adaptively reordered via TM. For a given CU predicted in inter, a merge mode derives all the motion information from the spatially and temporally neighboring CUs, which are called merge candidates. The reordering method is applied to regular merge mode, TM merge mode, and affine merge mode (excluding the SbTMVP candidate). For the TM merge mode, merge candidates are reordered before the refinement process. Basically, when ARMC is used, the merge candidates with less template distance to the current block template are put on top of the list.

After building a merge candidate list, merge candidates are divided into several subgroups. The subgroup size is set to 5 for regular merge mode and TM merge mode. The subgroup size is set to 3 for affine merge mode. Merge candidates in each subgroup are reordered ascendingly according to cost values based on template matching. For simplification, merge candidates in the last but not the first subgroup are not reordered.

The template matching cost of a merge candidate is measured by the SAD between the reconstructed samples of a template of the current block and their corresponding reference (in terms of motion, not in the intra sense) samples of the template associated with the reference (in terms of motion, not in the intra sense) block. The template comprises a set of reconstructed samples surrounding the current block to be encoded/decoded. Reference (in terms of motion, not in the intra sense) samples of the template of the reference block are located by the motion information of the merge candidate.

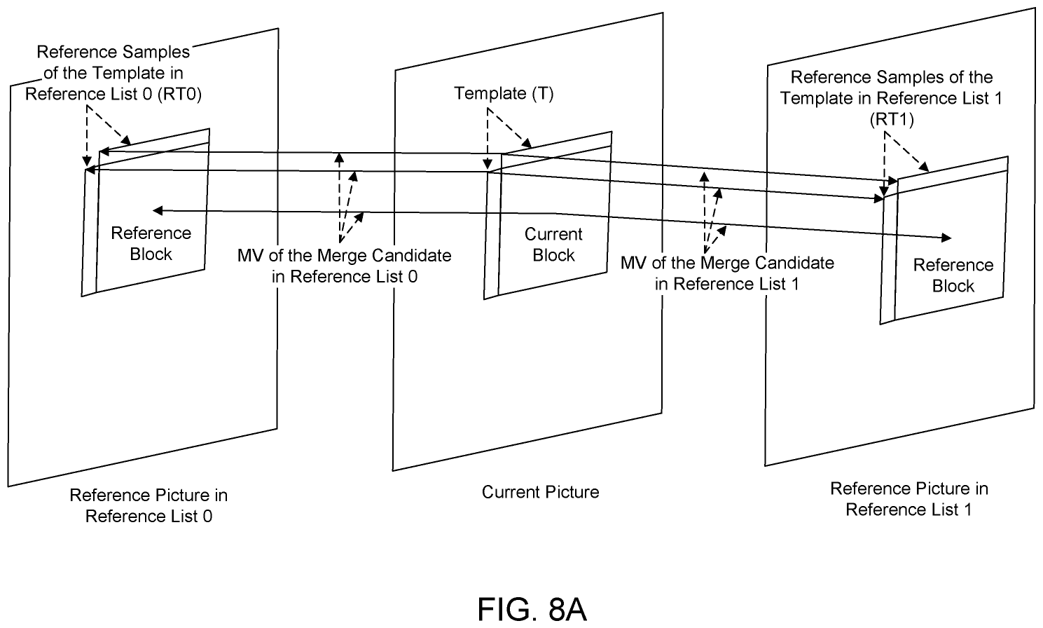

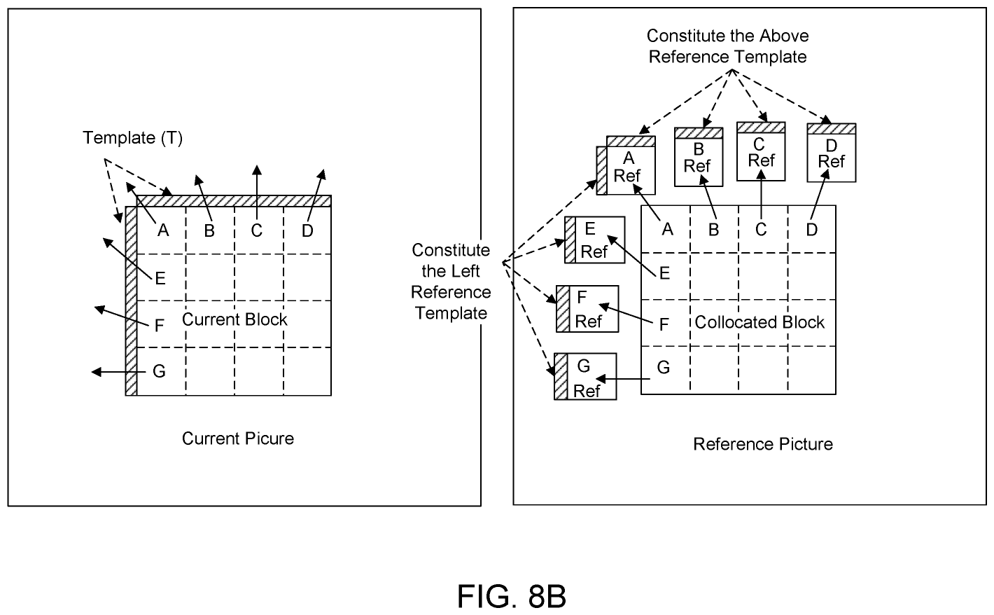

When a merge candidate utilizes bi-directional prediction, the reference (in terms of motion, not in the intra sense) samples of the template of the merge candidate are also generated by bi-prediction as depicted in FIG. 8A. FIG. 8A thus illustrates the identification of the reference (in terms of motion) samples of the template T of the current block to be encoded/decoded in the case of a bi-directional merge candidate: (1) identification of the reference (in terms of motion) samples, in the reference picture of the reference list 0, of the template T surrounding the current block to be encoded/decoded using the motion vector of the merge candidate in reference list 0 and (2) identification of the reference (in terms of motion) samples, in the reference picture of the reference list 1, of the template T surrounding the current block to be encoded/decoded using the motion vector of the merge candidate in reference list 1.

For subblock-based merge candidates with subblock size equal to Wsub×Hsub, the above template comprises several sub-templates of size Wsub×1 and the left template comprises several sub-templates of size 1×Hsub. As illustrated in FIG. 8B, the motion information of the subblocks in the first row and the first column of current block to be encoded/decoded is used to derive the reference (in terms of motion) samples of each sub-template.

### Matrix-Based Intra Prediction (MIP)

MIP consists in linear intra prediction modes with learned matrices fixed on both the encoder and decoder sides. The prediction of the current W×H luminance CB via a MIP mode comprises the three following steps. First, the W decoded reference samples above the current luminance CB and the H decoded reference samples on its left side are downsampled. Then, the result of the downsampling is linearly transformed into a reduced prediction. Finally, if needed, the reduced prediction is linearly interpolated such that the interpolated prediction has the same size as the current W×H luminance CB.

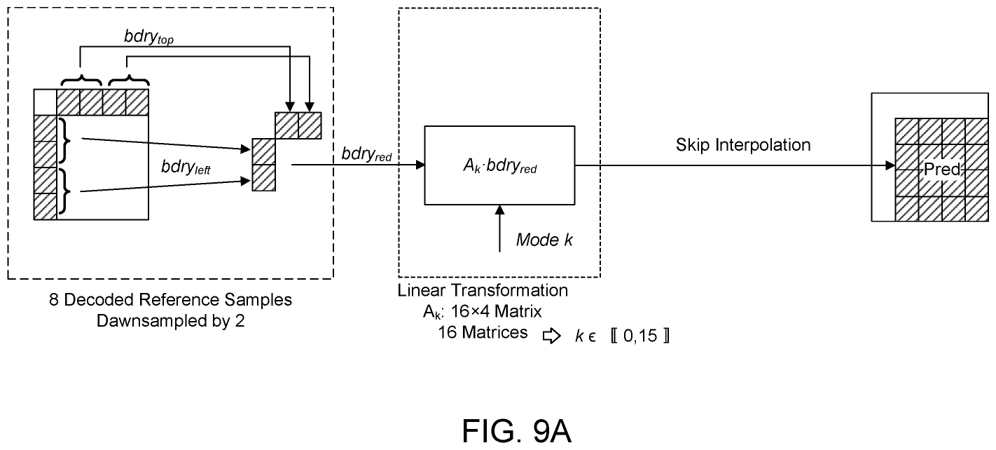

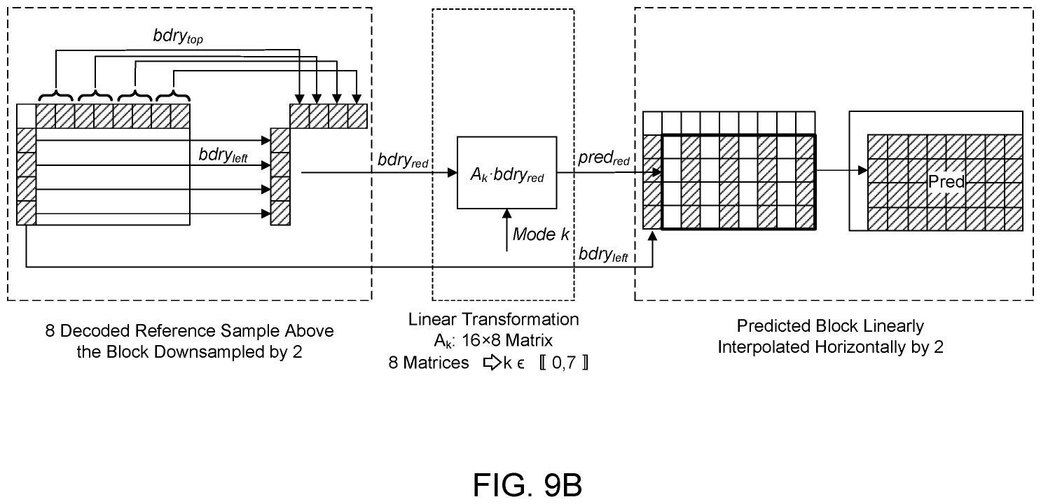

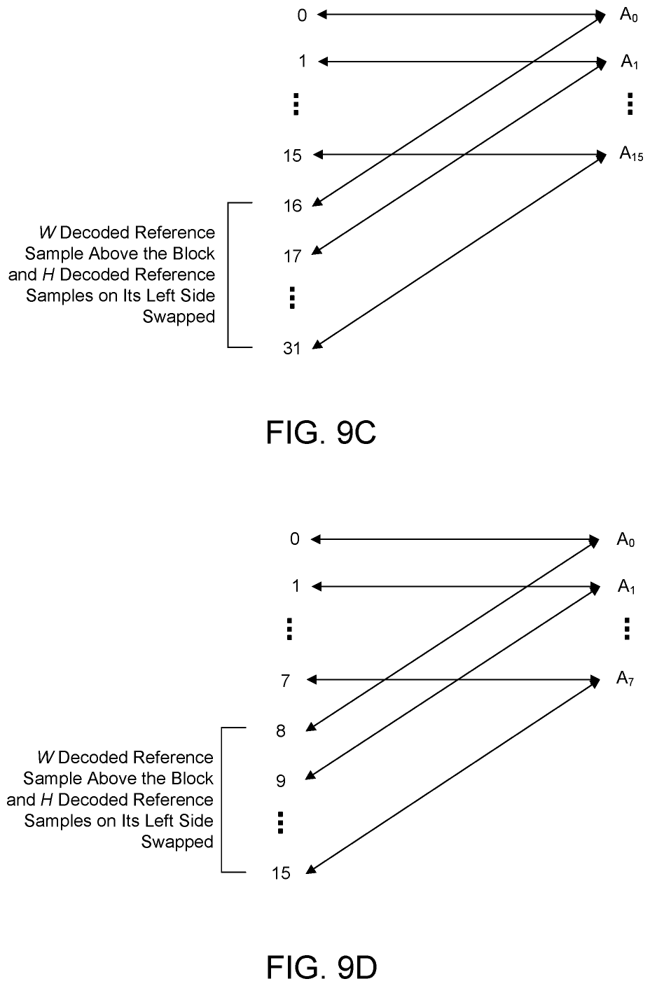

More precisely, if W=4 and H=4, the downsampling factor is 2. Besides, the MIP matrix in the linear transform has size 16×4 (4 input samples and 16 output samples), as shown in FIG. 9A. If either W=4 and H=8 or W=8 and H=4 or W=8 and H=8, the downsampling factor for the W decoded reference samples is W/4 and the downsampling factor for the H decoded reference samples is H/4. Besides, the MIP matrix in the linear transform has size 16×8 (8 input samples and 16 output samples), as shown in FIG. 9B. For all the other block sizes, the downsampling factor for the W decoded reference samples is W/4 and the downsampling factor for the H decoded reference samples is H/4. Besides, the MIP matrix in the linear transform has size 64×8 (8 input samples and 64 output samples). Note that, for the interpolation step, a horizontal interpolation of the reduced prediction uses some of the H decoded reference samples, not their downsampled version. A vertical interpolation of the reduced prediction uses some of the W decoded reference samples, not their downsampled version.

If W=4 and H=4, there exist 32 MIP modes. These modes are split into pairs, each pair using the same MIP matrix, but, for the second mode of each pair, the downsampled reference samples above the current luminance CB and the downsampled reference samples on its left side are swapped. The mapping from the MIP mode index to the MIP matrix index is depicted in as shown in FIG. 9C. When the swap of the downsampled reference samples applies, the reduced prediction is transposed before being interpolated. If W=4 and H=8 or W=8 and H=4 or W=8 and H=8, there are 16 MIP modes and the mode pairing still applies, as shown in FIG. 9D. For all the other block sizes, 12 MIP modes are used and the mode pairing still applies.

Template-Based Neural Networks without Translation Equivariance

In parallel to standardization, new template-based tools based on neural-network have been developed. Considering two dimensions of translation, the translation equivariance of a neural network means that, if the input is shifted by (s₀, s₁) ∈ [symbol] ², the neural network output is also shifted by (s₀, s₁). Let us say that the input to the neural network has four dimensions, e.g. a Group of Pictures (GOP) Of YC_{b}Cᵣ frames. The translation equivariance of a neural network along the first two dimensions and the last dimension, e.g. the two spatial dimensions and the temporal dimension, means that, if the input is shifted by (s₀, s₁) ∈ [symbol] ² along the first two dimensions and by t ∈ [symbol] along the last dimension, the neural network output is also shifted by (s₀, s₁) along its first two dimensions and by t along its last dimension.

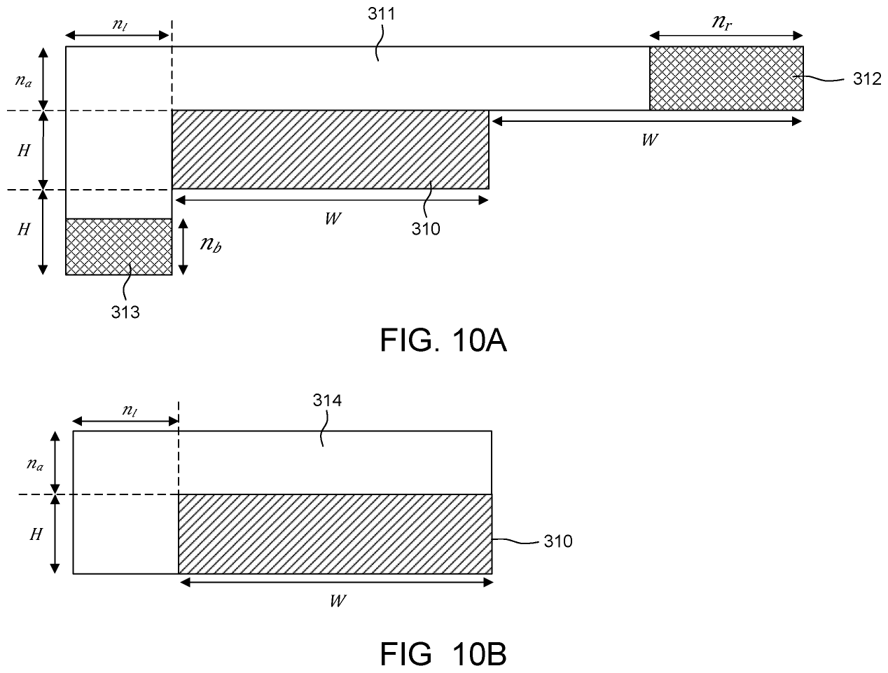

Apart from template-based tools with translation equivariance, there are template-based tools without translation equivariance. FIG. 10A and FIG. 10B depict examples of templates fed into typical template-based neural networks without translation equivariance. In a first example in FIG. 10A, for a given W×H block (310), the template (311) inserted into the neural network is made of nₐ rows of decoded pixels above this block and nₗ columns of decoded pixels on its left side. The template is extended to the right side of this block by W and below this block by H. In the extended portions of the template, the unavailable decoded pixels are substituted/padded following the process of unavailable decoded reference samples substitution specified by the HEVC and VVC standards. Therefore, the n_{b} ∈[|0, H|]bottommost rows (313) of unavailable decoded pixels and the nᵣ ∈[|0, W|] rightmost columns (312) of unavailable decoded pixels in the template are substituted, n_{b} and nᵣ depending on the encoding/decoding partitioning history. In a second example in FIG. 10B, for a given W×H block (310), the template (314) put into the neural network is this time not extended. In the two examples, the sequence of computations inside a neural network fed with the template of a W×H block never changes with the availability of the decoded pixels in the input template. This degrades the tradeoff between the quality of the neural network output and its inference complexity.

For a given block to be encoded (respectively decoded), the template, in its common design, comprises no decoded pixels on the above-right side of this block and no decoded pixels on its bottom-left side. In the case where the template comprises pixels on the above-right side of this block and pixels on its bottom-left side, the unavailable pixels in these two extended portions are usually substituted/padded following the process of unavailable decoded reference samples substitution specified by the HEVC and VVC standards. Either limiting the template to its common design or extending it while substituting/padding unavailable pixels degrades the relevance of the template-based tool's output and consequently the encoding efficiency of the block encoded from this output.

Yet, depending on the size of a current block, its position within its current Coding Tree Unit (CTU), and its position within the current frame, decoded pixels on the above-right side of this block and/or its bottom-left side may be available. If most of the relevant intensity textures are located on the above-right side of this block and/or on its bottom-left side, the fact that these decoded pixels are not included in the template can be viewed as a critical loss of available information.

Extending the template towards the above-right side of the block and its bottom-left side may thus be advantageous. In first embodiments, the extension towards the above-right side of this block can cover as many available decoded pixels as possible, in the limit of W additional columns of decoded pixels. The extension towards the bottom-left side of this block can cover as many available decoded pixels as possible, in the limit of H additional rows of decoded pixels. In other embodiments, there is no limit on the extensions. Finally, extended templates of various forms are proposed, e.g. template completely surrounding the current block.

In the template of a block to be encoded (decoded respectively), a pixel (e.g. a decoded pixel) may be unavailable because it has not been reconstructed/decoded yet due to the encoding/decoding partitioning history or because it is not accessible. A pixel may be inaccessible even if reconstructed because of specific coding constraints, e.g. because it belongs to a tile different from the tile to which the block to be encoded belongs or because it is located outside of frame boundaries. In the following, “unavailable pixel” and “unavailable decoded pixel” are used interchangeably.

In the present embodiments, an operation, e.g. a vector-matrix product, implemented in the template-based tool and involving this template is further fed with information for identifying which decoded pixel inside the template are unavailable in order to skip at least one part of this operation involving the unavailable decoded pixels. In some embodiments, a complete module of computations involving the unavailable decoded pixels may be skipped. As an example, in the case of a template-based tool fed with a template surrounding the current block to be encoded/decoded, this template being extended towards the above-right side of the block and its bottom-left side, if the template-based tool contains a filter specific to the two extended template portions and the decoded pixels in these two extended portions are all unavailable, this filtering may be skipped. The part of the operation may be a part of an elementwise multiplication between two tensors, a part of a vector-matrix product, a part of a vector reduction via downsampling.

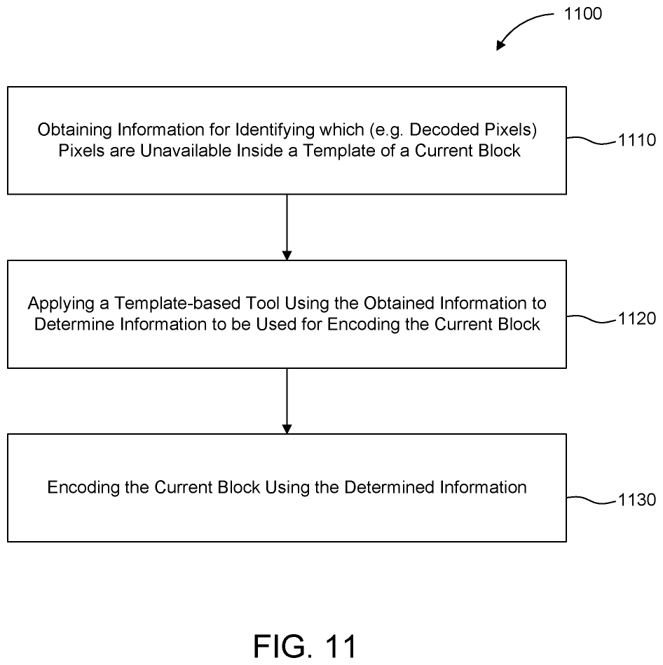

FIG. 11 illustrates a method 1100 for encoding a block using a template-based tool according to an embodiment. At 1110, information is obtained, wherein said information is for identifying which decoded pixels inside a template of the block are unavailable. This information is for example obtained responsive to partitioning history. For instance, in the case of a given frame encoded via VVC (having a top-left-to-bottom-right CTU scanning order and a hierarchy Z-scanning order for CUs), if the current CTU is split via a quadtree split and the current CU is the bottom-right CU resulting from this split, the partitioning history, i.e. the split depth (1), the type of split “quadtree”, and the index of the current CU resulting from this split (3), directly tells that all the decoded reference samples on the above-right side of the current CB in the current CU are unavailable. If a template of decoded reference samples around the current CB is to be extracted, this information on neighboring decoded reference samples unavailability may be the indices of the columns of unavailable decoded pixels in the template.

At 1120, the template-based tool is applied using the information obtained at 1110 to determine information to be used for encoding the block. More precisely, the information obtained at 1110 is used to skip at least one part of an operation implemented in said template-based tool and involving the unavailable decoded pixels.

At 1130, the block is encoded using the information determined by the template-based tool, e.g. a predicted block, prediction mode(s) index(ices), transform type, merge candidate ordering, etc. Encoding the block is done by determining a residue between the pixels of the block and a prediction and encoding the residue.

In an example, an encoding apparatus is disclosed that comprises one or more processors and at least one memory coupled to said one or more processors, wherein said one or more processors are configured to perform the above encoding method.

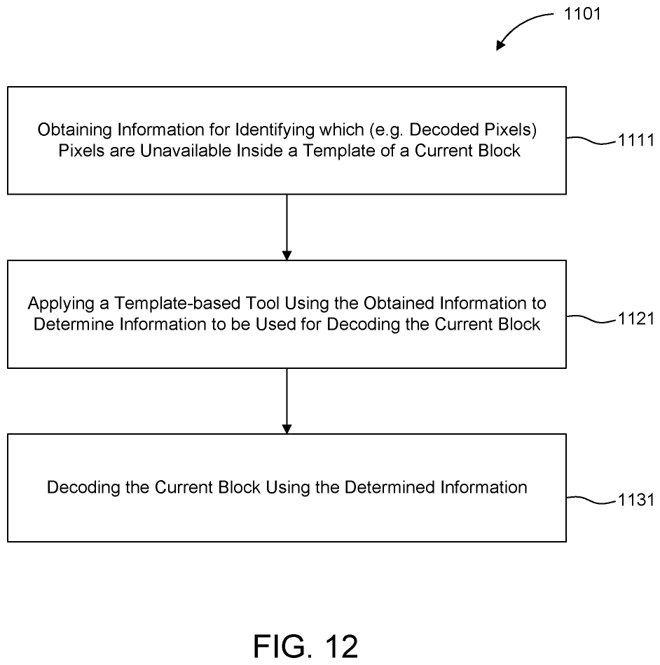

FIG. 12 illustrates a method 1101 for decoding a block using a template-based tool according to an embodiment. At 1111, information is obtained wherein said information is for identifying which decoded pixels inside a template of the block are unavailable. This information is, for example, obtained responsive to partitioning history.

At 1121, the template-based tool is applied using the information obtained at 1111 to determine information to be used for decoding the block. The information to be used for decoding the block is identical to the information to be used for encoding the block. More precisely, the information obtained at 1111 is used to skip at least one part of an operation implemented in said template-based tool and involving the unavailable decoded pixels. Steps 1111 and 1121 are identical to steps 1110 and 1120 of the encoder side.

At 1131, the pixels of the block are decoded using the information determined by the template-based tool, e.g. a predicted block, prediction mode(s) index(ices), etc. Decoding the block is done by decoding the residue and adding the residue to the prediction to reconstruct the pixels of the block.

The following examples apply to both the encoding and decoding methods.

In an example, applying a template-based tool using the obtained information comprises skipping a computation in the case where said computation involves a pixel identified as unavailable by the obtained information.

In an example, the method further comprises flattening the template prior to applying the template-based tool.

In an example, obtaining information for identifying which decoded pixels are unavailable inside a template of a current block comprises obtaining indices of all decoded pixels which are unavailable.

In an example, obtaining information for identifying which decoded pixels are unavailable inside a template of a current block comprises obtaining indices of all decoded pixels which are available.

In an example, obtaining information for identifying which decoded pixels are unavailable inside a template of a current block comprises obtaining flags, each flag indicating for a pixel in the template whether said pixel is available or not.

In an example, obtaining information for identifying which decoded pixels are unavailable inside a template of a current block comprises for a group of neighboring unavailable pixels, obtaining an index of a first unavailable pixel and an index of a last unavailable pixel in the group.

In an example, obtaining information for identifying which decoded pixels are unavailable inside a template of a current block comprises for a group of neighboring available pixels, obtaining an index of a first available pixel and an index of a last unavailable pixel in the group. In an example, the method further comprising spatially reorganizing pixels inside the template in order to increase a number of memory-contiguous available decoded pixels.

In an example, an unavailable decoded pixel is one of a pixel not reconstructed yet, a pixel belonging to a tile different from a tile to which the current block belongs or a pixel outside of picture boundaries.

In an example, said template-based tool belongs to a set of template-based tools comprising:
Decoder-side intra mode derivation;
Convolutional cross-component model;
Adaptive reordering of merge candidates with template matching;
Template matching prediction matrix-based intra prediction; and
Template-based neural-network prediction without translation equivariance.

In an example, the template comprises pixels located all around the current block.

In an example, the template comprises lines of pixels located above the current block and columns of pixels located on the right and left of the current block.

In an example, a decoding apparatus is disclosed that comprises one or more processors and at least one memory coupled to said one or more processors, wherein said one or more processors are configured to perform the above decoding method.

In an example, a computer program comprising program code instructions for implementing the steps of the above encoding (respectively decoding) method.

In an example, a computer readable storage medium having stored thereon instructions for encoding or decoding a block of a picture according to the above encoding (respectively decoding) method.

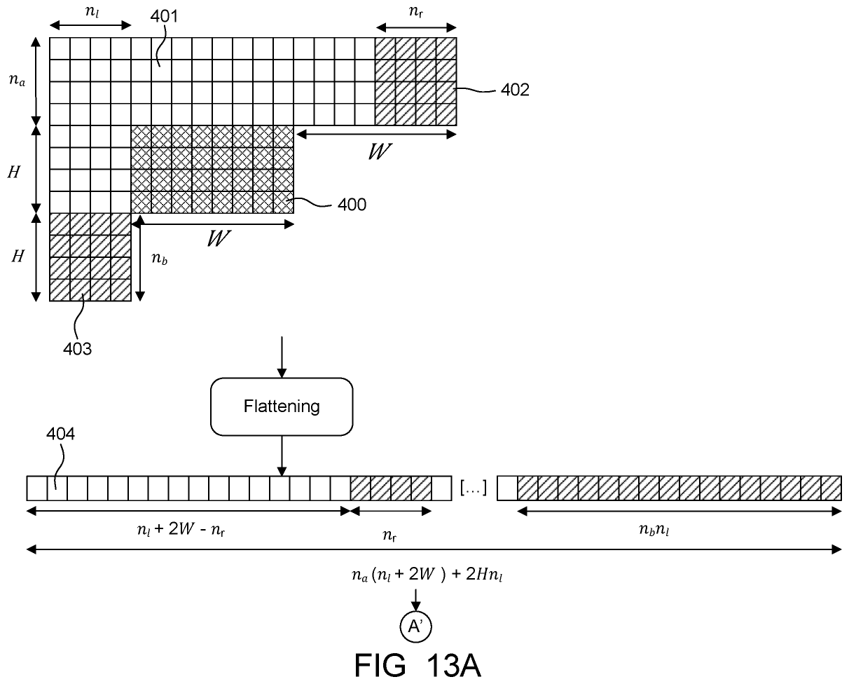

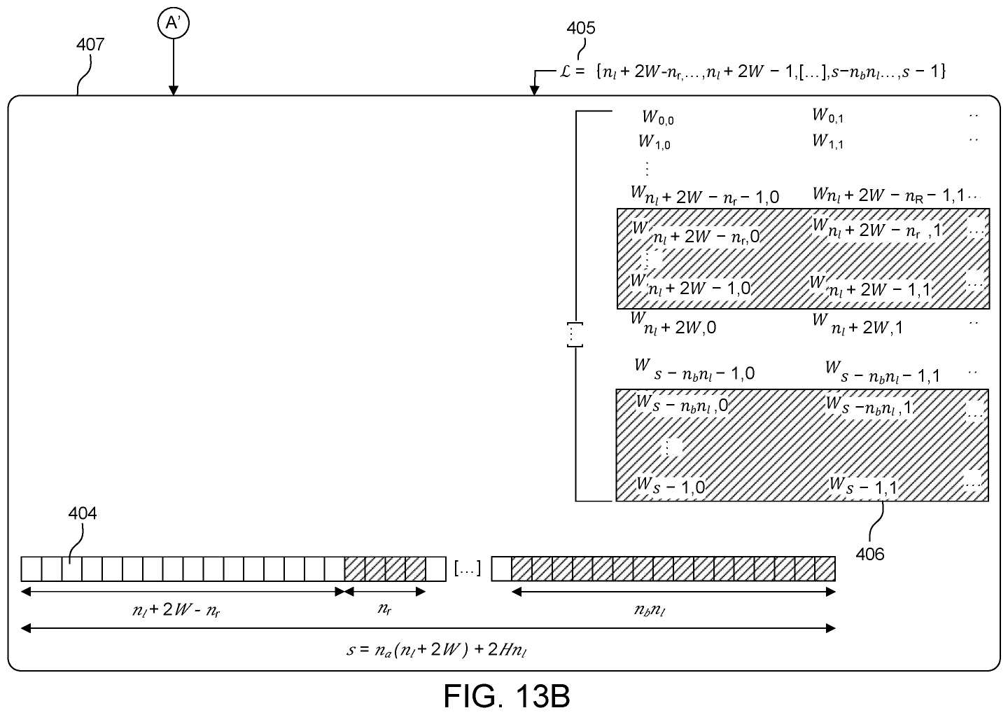

Additional embodiments are described below in relation to FIGS. 13A-26D.

### Embodiment 1

The information for identifying which decoded pixels inside a template of the block are unavailable may be a set [symbol] of indices of the unavailable decoded pixels in the template or in a transformed version of the template. This transformation can be any transformation, such as filtering, reshaping, rotation, flipping or splitting.

For instance, FIGS. 13A and 13B illustrate the methods of FIG. 11 and FIG. 12 in the case where the operation in the template-based tool is a vector-matrix product and the input template is first flattened. The template (401) of a given W×H block (400) contains n_{b} ∈[|0, H|] rows (403) of unavailable decoded pixels at its bottom and nᵣ ∈[|0, W|] columns (402) of unavailable decoded pixels on its right side. The notation [|a, b|] represents all the integers comprised in the range [a;b]. The template is first flattened, yielding (404). Then, the product (407) between the flattened template (404) and weight matrix (406) uses the set L of indices of unavailable decoded pixels (405) inside the flattened template to skip computations namely multiplications and additions. On this figure, the light gray squares indicate unavailable decoded pixels. In the weight matrix (406), the light gray areas contain the weights that are unused because computation skips. Said differently, the output coefficient of index j is expressed as

$${\sum }_{i ∈ [ \vert 0 , s - 1 \vert ] ∖ ℒ} {T}_{i} {w}_{i , j} \qquad ( Eq . 1 )$$

Tᵢ: coefficient of index i in the flattened template.

w_{i,j}: weight of index (i,j).

s: size of the flattened template.

In a first variant of Embodiment 1, the indices of any group of neighboring unavailable decoded pixels may be defined as the indices of the first unavailable decoded pixel and the last one. Consequently, each pair of indices in [symbol] is turned into the set of all the indices between the two indices of this pair, said pair of indices being included in the set. The above (Eq.1) remains unchanged except that [symbol] is defined differently: [symbol] ={(k (nₗ+2 W)−nᵣ, k(nₗ+2 W)−1 [symbol] ,(s−n_{b}nₗ, s−1)}.

In a second variant of Embodiment 1, the information for identifying which decoded pixels inside a template of the block are unavailable may be a set [symbol] of flags, each flag indicates whether the associated decoded pixel in the template or in a transformed version of the template is unavailable or not. In this embodiment, a flag equal to true indicates that the associated pixel is unavailable and a flag equal to false indicates that the associated pixel is available. In the example illustrated in FIGS. 13A and 13B, [symbol] may be defined as follows:

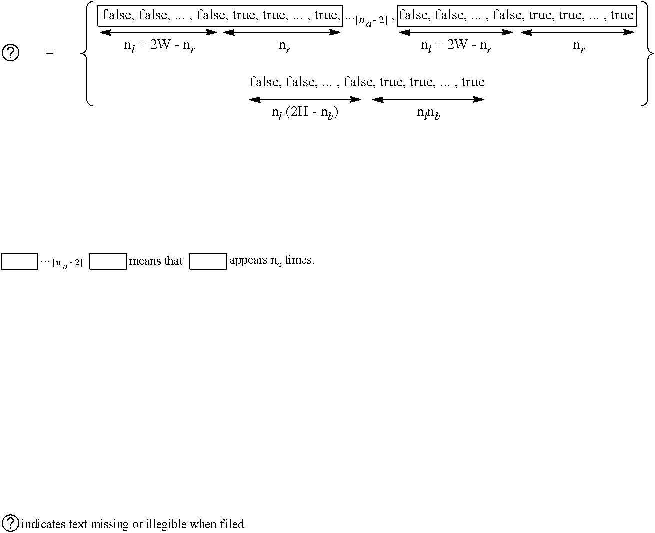

Indeed, the template comprises nₐ lines, each lines comprising (nₗ+2 W−nᵣ) available pixels (thus flags equal to false) followed by nᵣ unavailable pixels (thus flags equal to true), then (2H−n_{b}) lines of nₗ of available pixels (thus flags equal to false) and finally nₗn_{b} unavailable pixels of (thus flags equal to false).

Then, the output coefficient of index j is calculated as follows:

$${\sum }_{i ∈ [ \vert 0 , s - 1 \vert ] if ! \overline{ℒ} [ i ]} {T}_{i} {w}_{i , j}$$

### Embodiment 2

Instead of specifying which pixels in the template are unavailable, the information for identifying which decoded pixels inside a template of the block are unavailable may be a set [symbol] of indices of the available decoded pixels in the template or in a transformed version of the template. This transformation can be any transformation, such as filtering or reshaping or rotation or flipping or splitting.

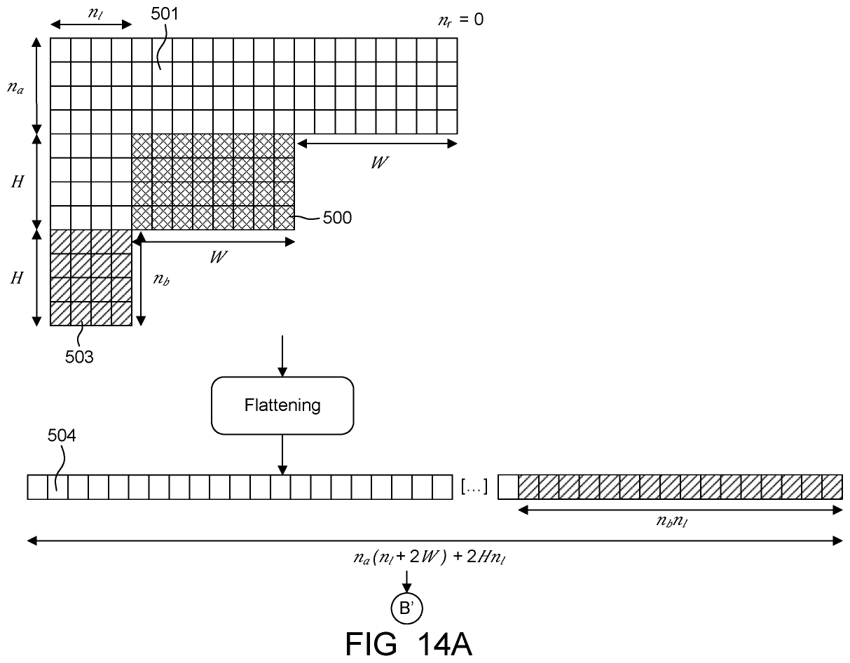

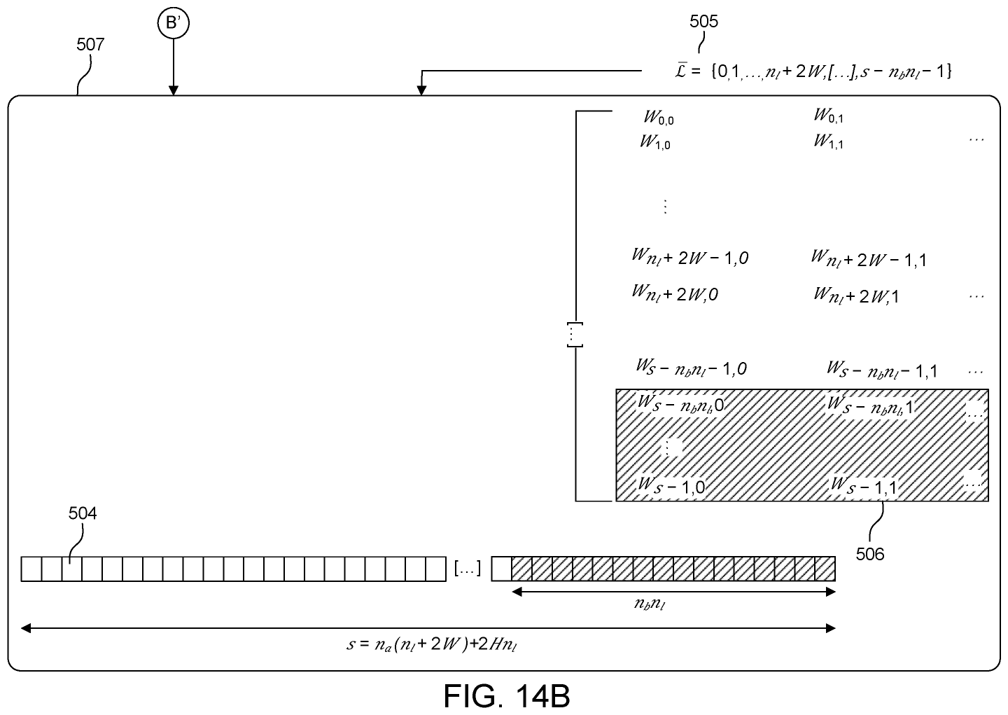

For instance, FIGS. 14A and 14B illustrate the methods of FIGS. 11-12 in the case where the operation in the template-based tool is a vector-matrix product and the input template is first flattened. The template (501) of a given W×H block (500) contains n_{b}∈[|0, H|] rows (503) of unavailable decoded pixels at its bottom. The template is first flattened, yielding (504). Then, the product (507) between the flattened template (504) and weight matrix (506) uses the set [symbol] of indices of available decoded pixels (505) inside the flattened template to skip multiplications and additions. On this figure, the light gray squares indicate unavailable decoded pixels. In the weight matrix (506), the light gray areas contain the weights that are unused because computations are skipped. In other words, the output coefficient of index j is expressed by the (Eq.2) below:

$${\sum }_{i ∈ \overline{ℒ}} {T}_{i} {w}_{i , j}$$

In a first variant of Embodiment 2, the indices of any group of neighboring available decoded pixels may be defined as the indices of the first available decoded pixel and the last one. Consequently, each pair of indices in [symbol] is turned into the set of all the indices between the two indices of this pair, said pair of indices being included in the set. The above (Eq.2) remains unchanged except that L is defined differently: [symbol] ={(0,s−n_{b}nₗ−1)}.

In a second variant of Embodiment 2, the information for identifying which decoded pixels inside a template of the block are unavailable may be a set [symbol] of flags, each flag indicates whether the associated decoded pixel in the template or in a transformed version of the template is available or not. In this embodiment, a flag equal to true indicates that the associated pixel is available and a flag equal to false indicates that the associated pixel is unavailable. In the example illustrated in FIGS. 14A and 14B, [symbol] may be defined as follows:

$$\overline{ℒ} = \{ {{true , true , … , true}_{↔}}_{{n}_{a} ( {n}_{l} + 2 W ) + {n}_{l} ( 2 H - {n}_{b} )} , {{false , false , … , false}_{↔}}_{{n}_{l} {n}_{b}} \}$$

Then, the output coefficient of index j is computed as

$${\sum }_{i ∈ [ \vert 0 , s - 1 \vert ] if ! \overline{ℒ} [ i ]} {T}_{i} {w}_{i , j}$$

### Embodiment 3

In this embodiment, the template may be transformed such that, in the transformed version of the template fed into the operation of interest within the template-based tool, the number of memory-contiguous available decoded pixels is increased. The transformation is for example a spatial reorganization of pixels inside the template in order to increase the number of memory-contiguous available decoded pixels. Indeed, the benefit of having as many decoded pixels with the same type of availability as possible next to one another is that, when skipping computations as explained in the previous embodiments, several acceleration methods can be better exploited for the non-skipped computations. For instance, let us say that AVX-512 is used. Let us also say that, in a potentially transformed version of the template fed into the operation of interest, each decoded pixel is stored as 16-bit integer. The higher is the number of packs of 32 memory-contiguous available decoded pixels, the better is the AXV-512 acceleration.

This embodiment may be combined with any of the previous embodiments 1 or 2 and with any of their variants. Examples are given below of the combination of this embodiment with the embodiment 1 disclosed with respect to FIGS. 13A and 13B.

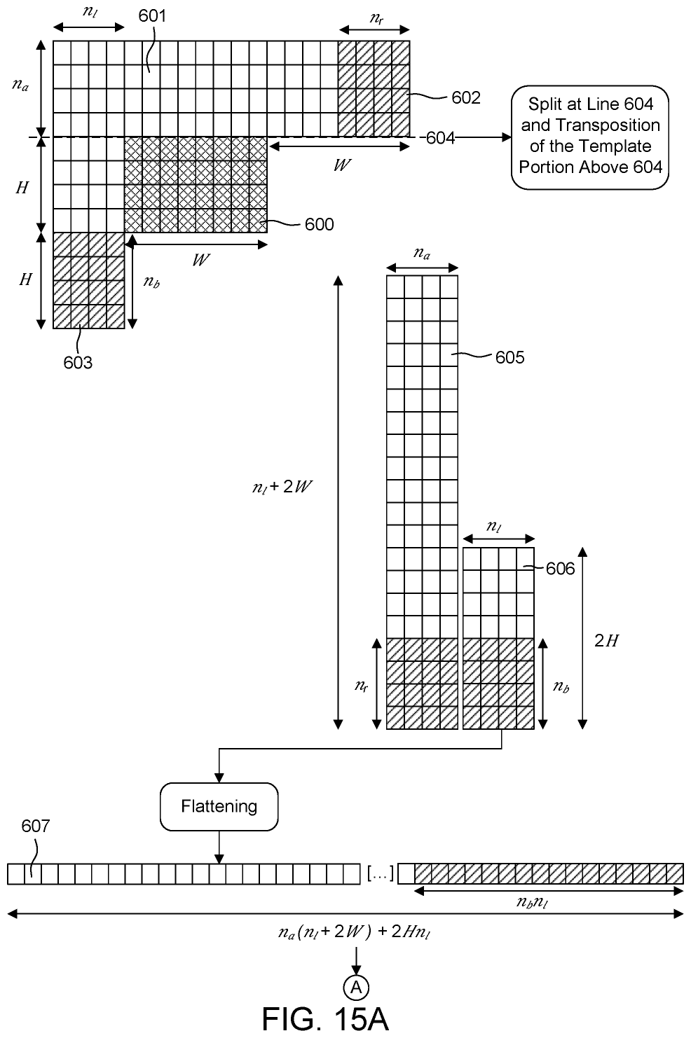

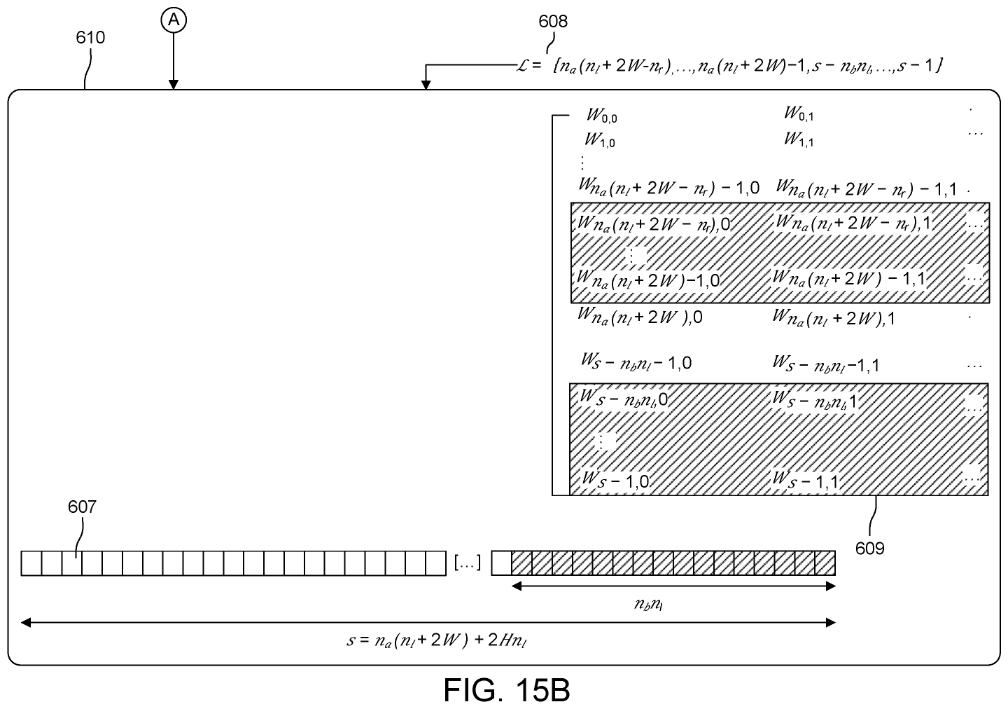

FIGS. 15A-15B provide an exemplar combination of Embodiment 3 and Embodiment 1, i.e. the information corresponds to the indices of the unavailable decoded pixels. Moreover, the operation of interest in the template-based video coding tool is a vector-matrix product and a flattening occurs before the vector-matrix product.

The template (601) of a given W×H block (600) contains n_{b} ∈[|0, H|] rows (603) of unavailable decoded pixels at its bottom and nᵣ ∈[|0, W|] columns (602) of unavailable decoded pixels on its right side. The template is first split at line (604) into two portions and the portion above line (604) is transposed, yielding (605) and (606). Then, (605) and (606) are flattened into a single vector (607). Finally, the product (610) between the flattened template (607) and weight matrix (609) uses the set [symbol] of indices of unavailable decoded pixels (608) inside the flattened template to skip multiplications et additions. In this example, (607) contains only two distinct groups of memory-contiguous available decoded pixels.

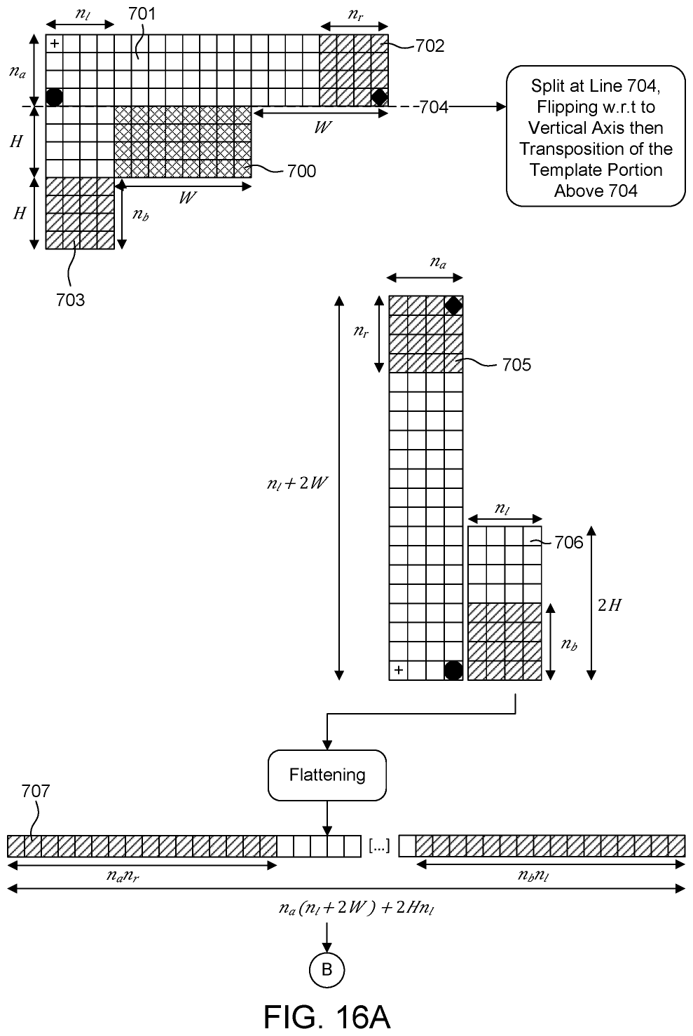

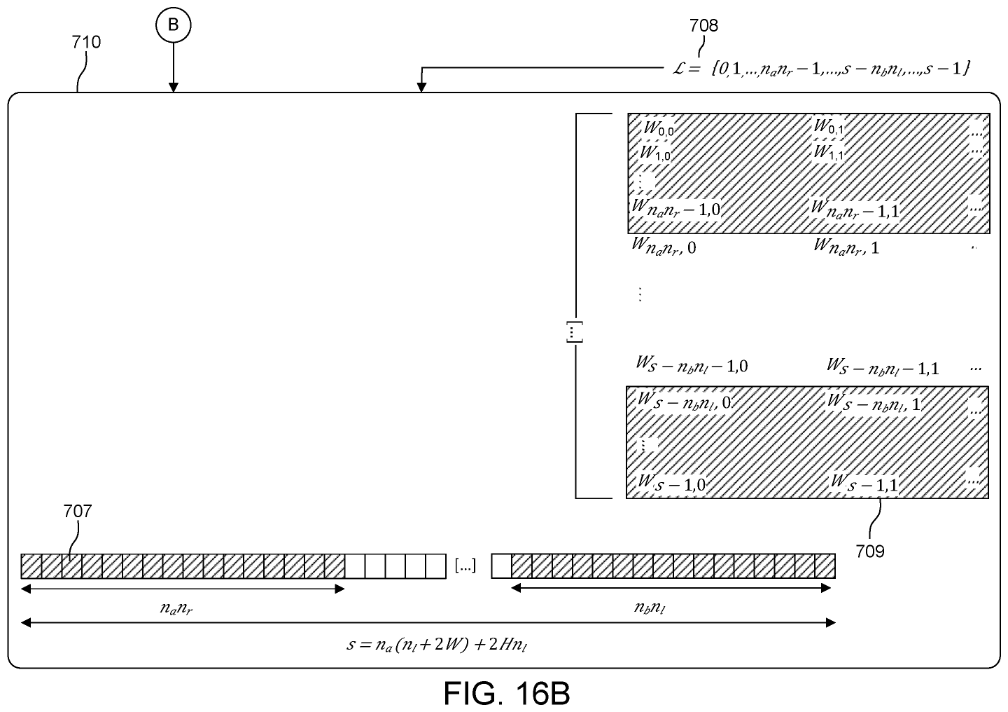

FIGS. 16A-16B provides another exemplar combination of Embodiment 3 and Embodiment 1, i.e. the information corresponds to the indices of the unavailable decoded pixels. Moreover, the operation of interest in the template-based video coding tool is a vector-matrix product and a flattening occurs before the vector-matrix product. On this figure, the cross, circle, and diamond just help to visualize the cascade of flipping with respect to the vertical axis and transposition.

The template (701) of a given W×H block (700) contains n_{b} ∈[|0, H|] rows (703) of unavailable decoded pixels at its bottom and nᵣ ∈[|0, W|] columns (702) of unavailable decoded pixels on its right side. The template is first split at line (704) into two portions and the portion above line 704 is flipped with respect to the vertical axis then transposed, yielding (705) and (706). Then, (705) and (706) are flattened into a single vector (707). Finally, the product (710) between the flattened template (707) and weight matrix (709) uses the set [symbol] of indices of unavailable decoded pixels (708) inside the flattened template to skip multiplications et additions. In this example, (707) contains a single group of memory-contiguous available decoded pixels.

In this embodiment, [symbol] may contain the index nₐnᵣ−1 of the last unavailable decoded pixel belonging to the first memory-contiguous group of unavailable decoded pixels in (707) and the index n_{b}nₗ−1, the indexing starting this time from the vector end, of the first unavailable decoded pixel belonging to the second memory-contiguous group of unavailable decoded pixels in (707). This makes it possible to have a compact representation of the information for identifying which decoded pixels inside the template are unavailable.

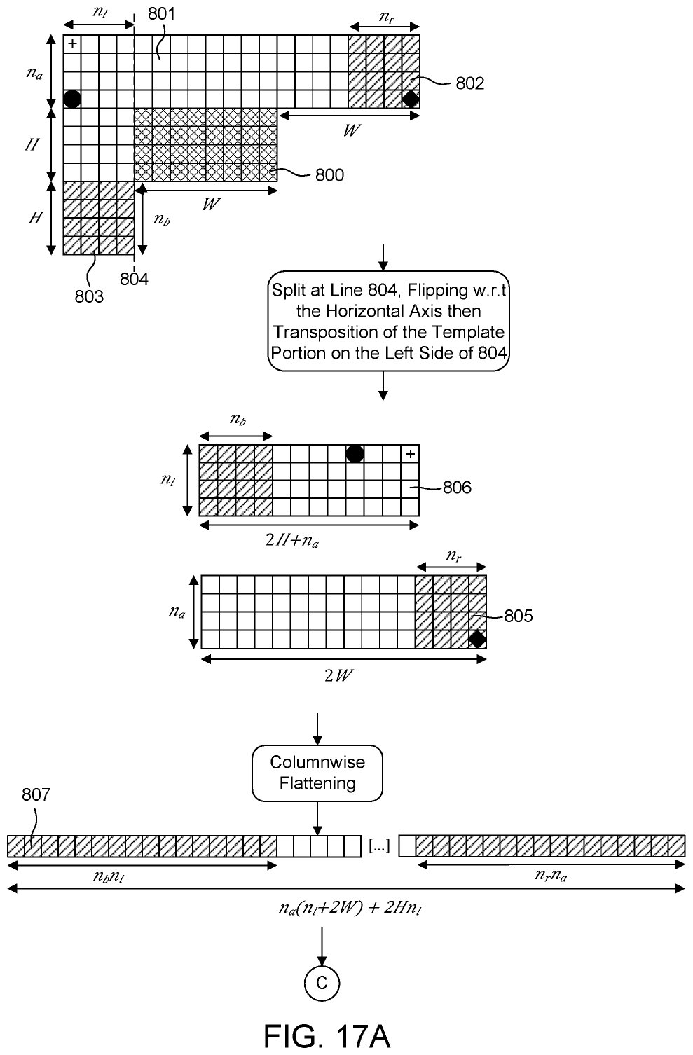

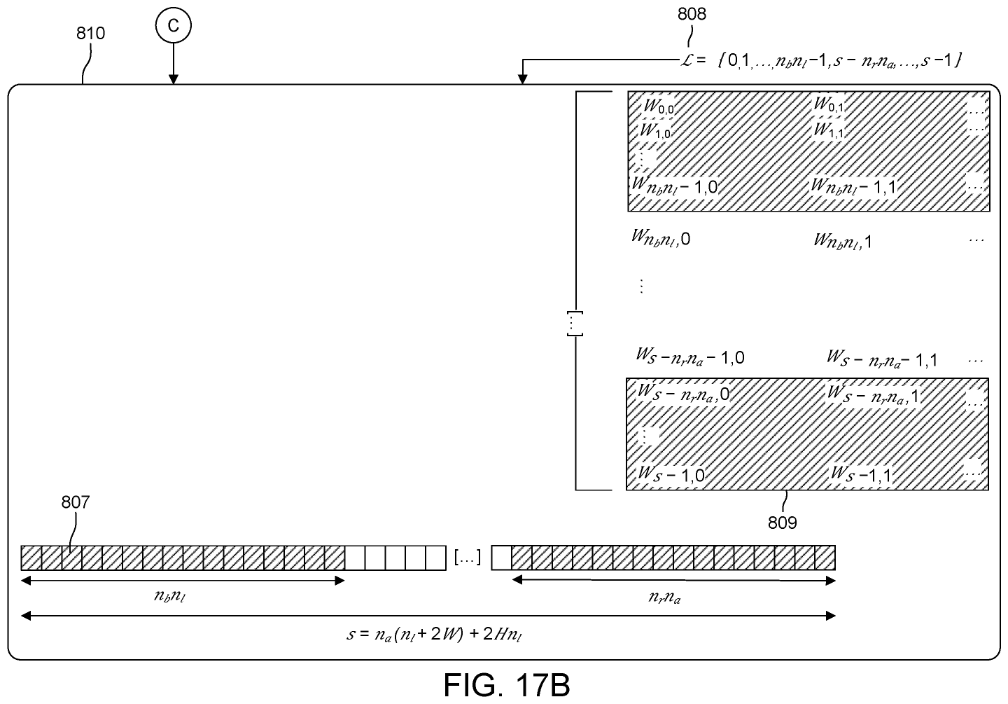

FIGS. 17A-17B provide another exemplar combination of Embodiment 3 and Embodiment 1, i.e. the information corresponds to the indices of the unavailable decoded pixels. Moreover, the operation of interest in the template-based video coding tool is a vector-matrix product and a column-wise flattening occurs before the vector-matrix product. On this figure, the cross, circle, and diamond just help to visualize the cascade of flipping with respect to the horizontal axis and transposition.

The template (801) of a given W×H block (800) contains n_{b} ∈[|0, H|] rows (803) of unavailable decoded pixels at its bottom and nᵣ ∈[|0, W|] columns (802) of unavailable decoded pixels on its right side. The template is first split at line (804) into two portions and the portion on the left side of line 804 is flipped with respect to the horizontal axis then transposed, yielding (805) and (806). Then, (805) and (806) are flattened column-wise into a single vector (807). The column-wise flattening means that (806) and (805) are scanned column-wise from left to right, each column from top to bottom, successively to yield (807). Finally, the product (810) between the flattened template (807) and weight matrix (809) uses the set L of indices of unavailable decoded pixels (808) inside the flattened template to skip multiplications et additions. In this example, (807) contains a single group of memory-contiguous available decoded pixels.

In this embodiment, [symbol] may contain the index n_{b}nₗ —1 of the last unavailable decoded pixel belonging to the first memory-contiguous group of unavailable decoded pixels in (807) and the index nₐnᵣ−1, the indexing starting this time from the vector end, of the first unavailable decoded pixel belonging to the second memory-contiguous group of unavailable decoded pixels in (807). This makes it possible to have a compact representation of the information for identifying which decoded pixels inside the template are unavailable.

### Embodiment 4

In this embodiment, some of the decoded pixels may be inaccessible while being already reconstructed because of specific constraint, e.g. independency of tiles during the encoding/decoding.

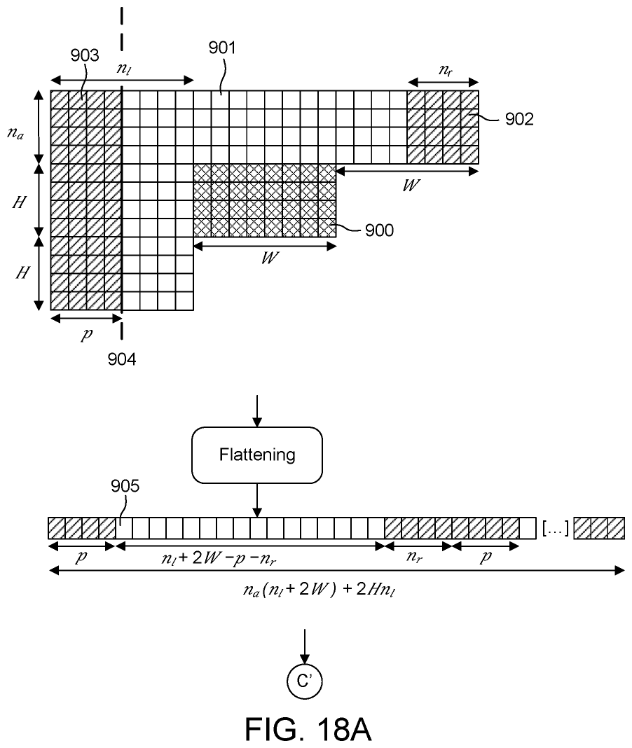

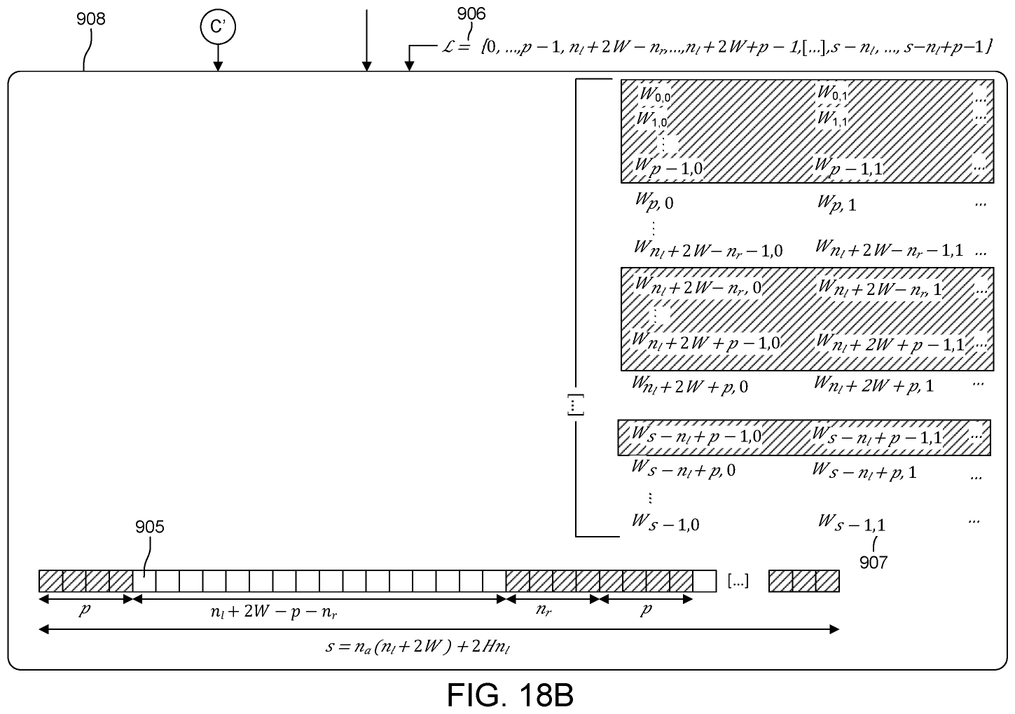

For instance, FIGS. 18A and 18B illustrate the methods of FIG. 11-12 in the case where the operation in the template-based tool is a vector-matrix product, the current frame is split into multiple tiles and the input template is first flattened. The template (901) of a given W×H block (900) contains nᵣ ∈[|0, W|] columns (902) of unavailable decoded pixels on its right side. Moreover, the p ∈[|0, nₗ|] leftmost columns of decoded pixels (903) inside the template (901) belong to the tile on the left side of the tile comprising the block (900). The boundary between these two tiles is denoted (904). The template is first flattened, yielding (905). Then, the product (908) between the flattened template (905) and weight matrix (907) uses the set [symbol] of indices of decoded pixels that are unavailable or inaccessible as the input template overlaps two tiles (906) inside the flattened template to skip multiplications et additions. On this figure, the light gray squares indicate decoded pixels that are unavailable due to the encoding/decoding partitioning history or inaccessible as the input template overlaps two tiles. In the weight matrix (907), the light gray areas contain the weights that are unused because computation skips. As in Embodiment 1, the output coefficient of index j is expressed as

$${\sum }_{i ∈ [ \vert 0 s - 1 \vert ] ℒ} {T}_{i} {w}_{i , j}$$

All the embodiments 1-3 and their variants may be combined with the embodiment 4. In particular, the set [symbol] of indices of decoded pixels that are available or accessible may be indicated instead of the set [symbol] as above.

### Embodiment 5

In this embodiment, some of the decoded pixels may be inaccessible while being already reconstructed because of specific constraint, e.g. independency of tiles during the encoding/decoding or because outside of the frame boundaries.

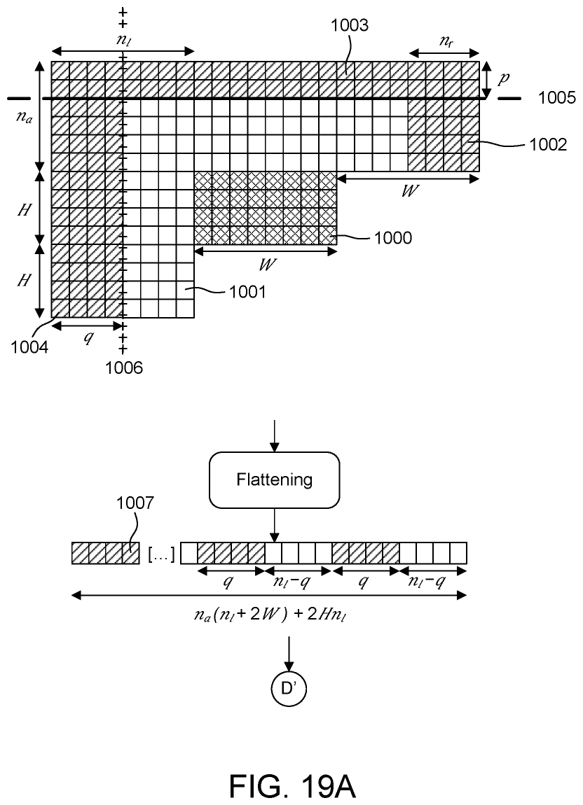

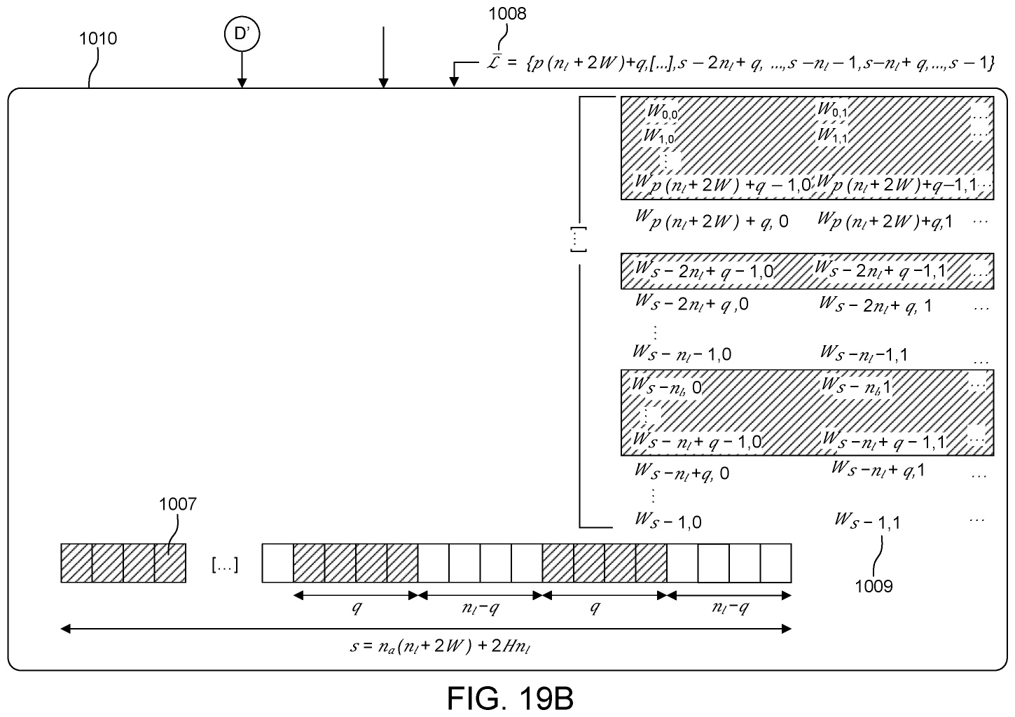

For example, FIGS. 19A and 19B illustrate the methods of FIG. 11-12 in the case where the operation in the template-based tool is a vector-matrix product, the current frame is split into multiple tiles, the template of the block goes outside the boundaries of the frame comprising this block and the input template is first flattened. The template (1001) of a given W×H block (1000) contains nᵣ ∈[|0, W|] columns (1002) of unavailable decoded pixels on its right side. Moreover, the p ∈[|0, nₐ|] topmost rows of decoded pixels (1003) inside the template (1001) belong to the tile above the tile comprising the block (1000). The boundary between these two tiles is denoted (1005). Moreover, the q∈[|0, nₗ|] leftmost columns of decoded pixels (1004) inside the template (1001) go out of the left bound (1006) of the frame comprising the block (1000). The template is first flattened, yielding (1007). Then, the product (1010) between the flattened template (1007) and weight matrix (1009) uses the set [symbol] of indices of decoded pixels that are available or accessible given the position of the template with respect to the tile boundaries and the frame boundaries (1008) inside the flattened template to skip multiplications et additions. On this figure, the light gray squares indicate decoded pixels that are unavailable due to the encoding/decoding partitioning history or inaccessible as the input template overlaps two tiles or goes outside of the frame boundaries. In the weight matrix (1009), the light gray areas contain the weights that are unused because computation skips. As in Embodiment 2, the output coefficient of index j is expressed as

$${\sum }_{i ∈ \overline{ℒ}} {T}_{i} {w}_{i , j}$$

All the embodiments 1-3 and their variants may be combined with the embodiment 5. In particular, the set [symbol] of indices of decoded pixels that are unavailable or inaccessible may be indicated instead of the set [symbol] as above.

### Embodiment 6

The previously described embodiments may be extended such that the template-based tool handles templates of multiple sizes. In this case, the template-based tool may be associated with a set [symbol] of block sizes for which the template of each block of size in S can be handled. Then, the template-based tool may be built to be fed with a “maximum template”, i.e. the template with each dimension being the maximum corresponding dimension over the block sizes in [symbol] .

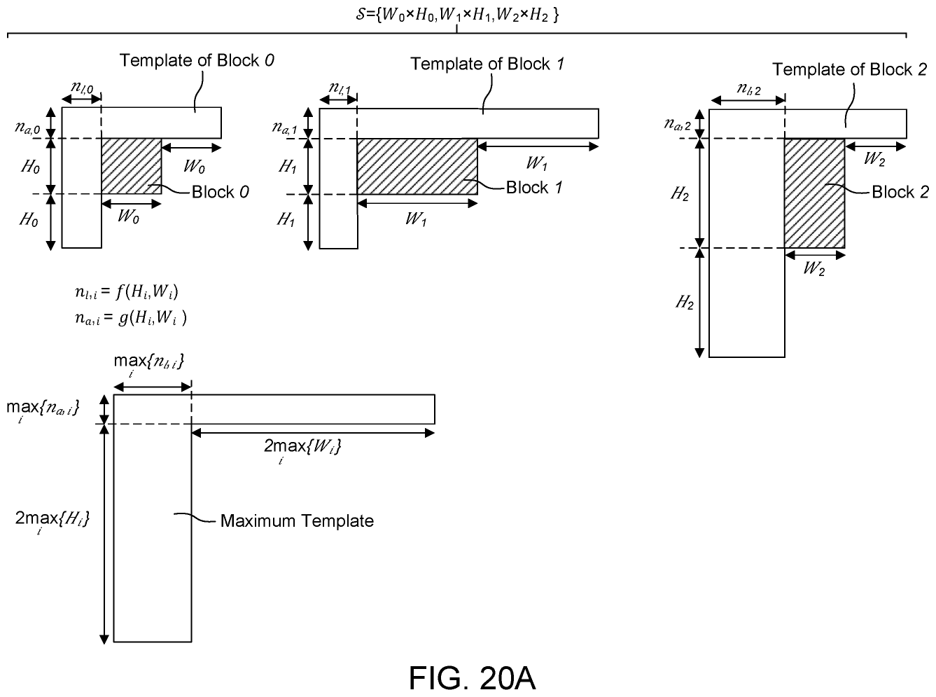

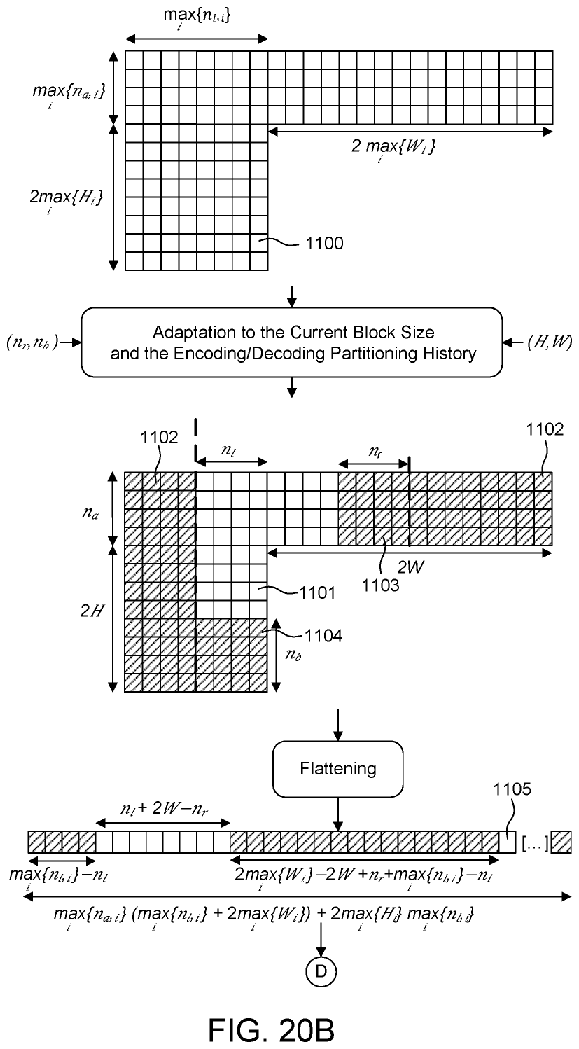

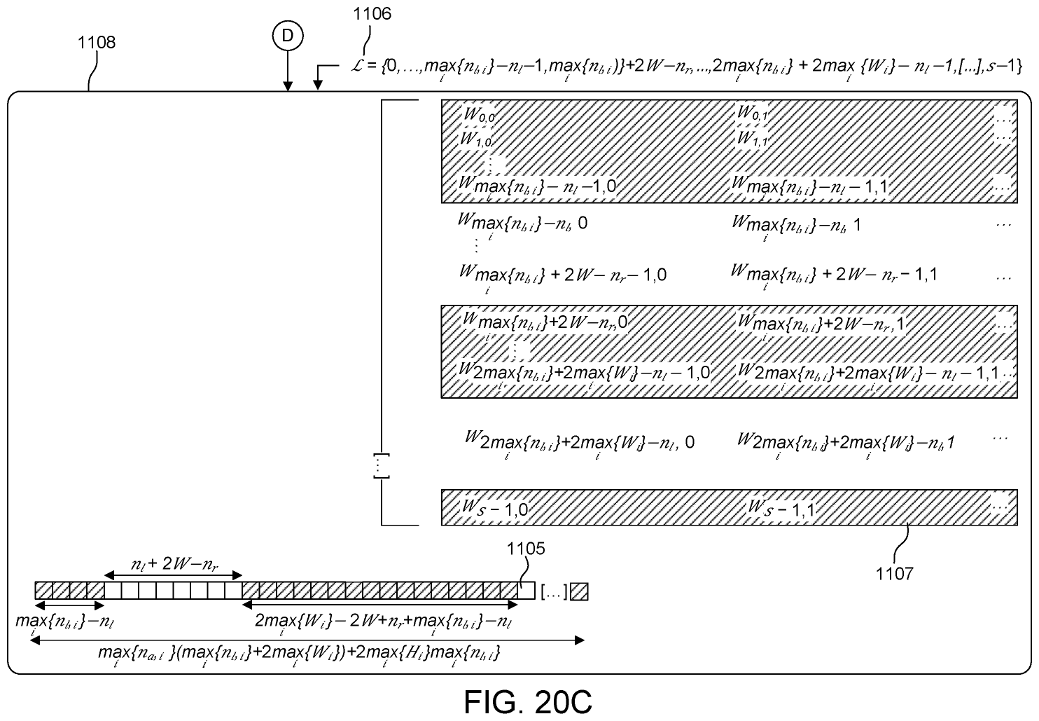

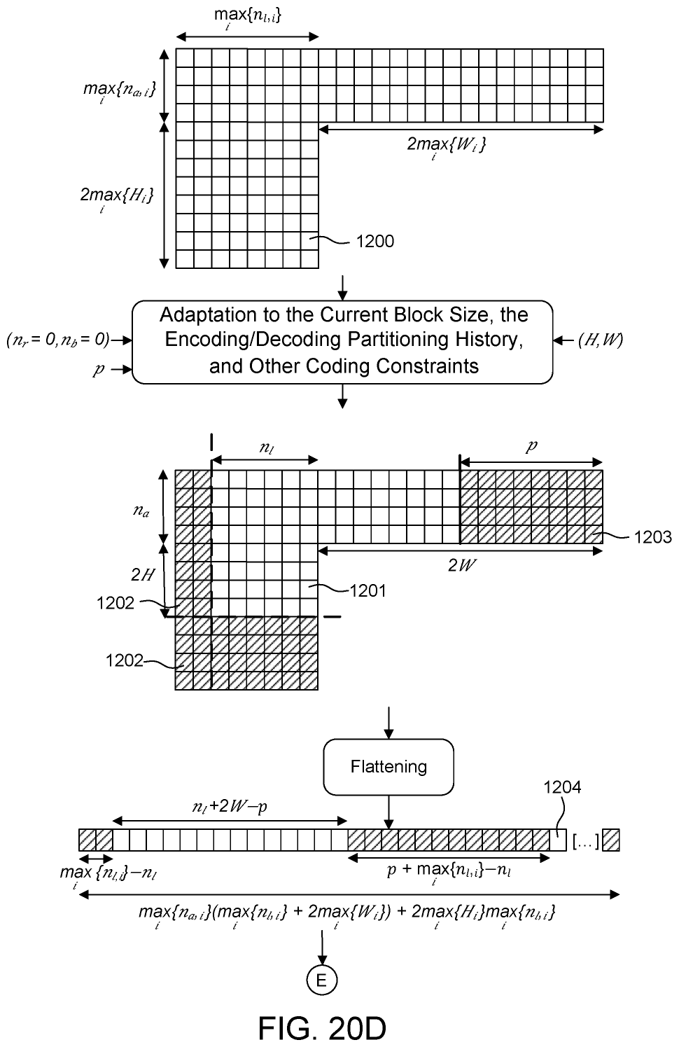

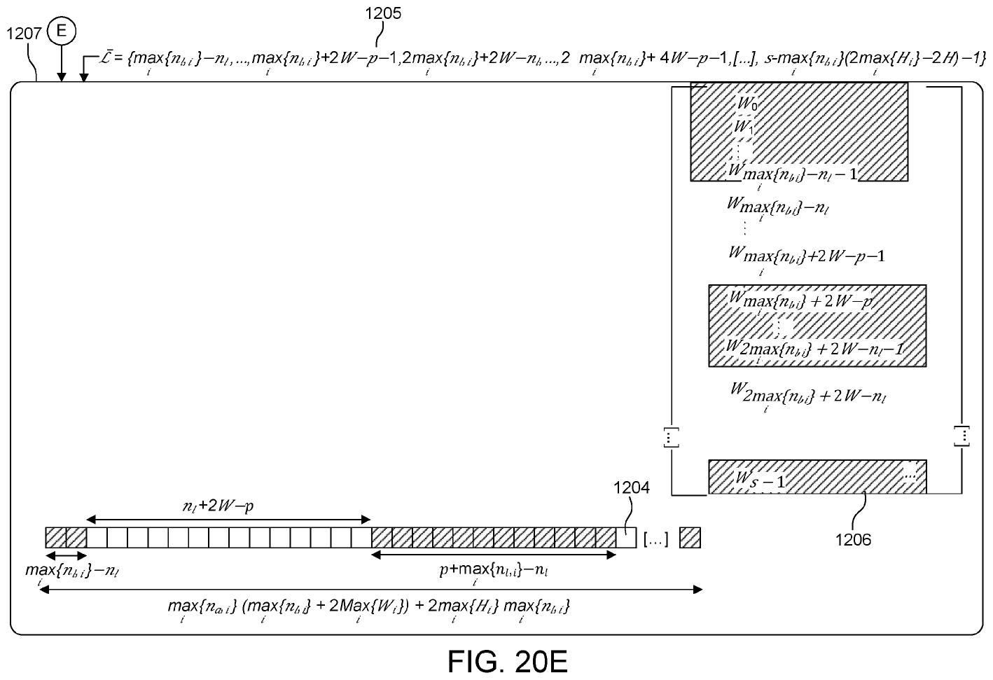

FIG. 20A provides exemplar definitions of the set S of block sizes and the “maximum template” for a template-based tool handling the template of each block size in [symbol] . In the template of a given Wᵢ×Hᵢ block, the number n_{l,i} of columns of decoded pixels on the left side of this block and the number n_{a,i} of rows of decoded pixels above this block may be functions of Hᵢ and/or Wᵢ, n_{l,i}=f(Hᵢ,Wᵢ) and n_{a,i}=g(Hᵢ, Wᵢ). f and g may be functions of Hᵢ and/or Wᵢ expressed as equations or tables. As an example, n_{l,i}=min(Hᵢ, Wᵢ)=n_{a,i}. According to another example.

| Hᵢ | Wᵢ | n_{l, i} |
|---|---|---|
| 2 | 4 | 8 |
| 4 | 2 | 4 |
| 8 | 2 | 12 |
| . . . | | |
| 16 | 16 | 16 |

This simplifies the definition of the “maximum template” because the shape of the “maximum template” can be directly deduced from [symbol] .

For any given W×H block, W×H∈ [symbol] , the template of this block may be put into the “maximum template”. The coefficients in the “maximum template” located outside the template of this block may be considered as unavailable. Consequently, all embodiments disclosed previously may be applied.

For example, FIGS. 20B-20C illustrate the methods of FIG. 11-12 in the case where the operation in the template-based tool is a vector-matrix product and the input template is first flattened.

The “maximum template” (1100) is first defined from [symbol] . Given the size W×H of the block of interest and the encoding/decoding partitioning history from which (nᵣ, n_{b}) are derived, the template (1101) of this block is put into the “maximum template”. The two vertical bold dashed lines separate (1101) from the coefficients of the “maximum template” not belonging to (1101). The coefficients of the “maximum template” not belonging to (1101), denoted (1102), are viewed as unavailable. (1101) contains n_{b} ∈[|0, H|] rows (1104) of unavailable decoded pixels at its bottom and nᵣ ∈[|0, W|] columns (1103) of unavailable decoded pixels on its right side. The filled “maximum template” is flattened, yielding (1105). Finally, the product (1108) between the flattened filled “maximum template” (1105) and weight matrix (1107) uses the set [symbol] of indices of unavailable decoded pixels (1106) inside (1105) to skip multiplications and additions. In the template (1100) and its flattened version (1105), the light gray squares indicate decoded pixels that are unavailable due to the partitioning history or inaccessible due to other constraints, e.g. tiles, frame boundaries. In the weight matrix (1107), the light gray areas contain the weights that are unused because of computation skips. In this embodiment, the set [symbol] is thus used to specify the pixels in the “maximum template” (1105) which are not part of the template (1101) of the block and which are thus considered as unavailable.

For example, FIGS. 20D-20E illustrate the methods of FIG. 11-12 in the case where the operation in the template-based tool is an elementwise vector-vector product and the input template is first flattened.

The “maximum template” (1200) is first set up using [symbol] . Given the size W×H of the block of interest, the encoding/decoding partitioning history, and the other coding constraints, the template (1201) of this block is inserted into the “maximum template”. The two bold dashed lines separate (1201) from the coefficients of the “maximum template” not belonging to (1201). The coefficients of the “maximum template” not belonging to (1201), denoted (1202), are viewed as unavailable. The p ∈[|0, W|]rightmost columns (1203) of the template (1201) belong to the tile located on the right side of the tile comprising the block of interest. The boundary between these two tiles is the bold vertical line in FIG. 20D. The filled “maximum template” is flattened, giving rise to (1204). Finally, the elementwise product (1207) between the flattened filled “maximum template” (1204) and weight vector (1206) uses the set [symbol] of indices of available decoded pixels (1205) inside (1204) to skip multiplications. In the template (1200) and its flattened version (1204), the light gray squares indicate decoded pixels that are unavailable due to partitioning history or inaccessible due to other constraints. In the weight vector (1206), the light gray areas contain the weights that are unused because of computation skips. The coefficient of index j resulting from the vector-vector elementwise multiplication may expressed as

$${T}_{i} {w}_{i} if \overline{ℒ} [ i ] ; default value otherwise$$

If the index of a given decoded pixel in the potentially transformed version of the template fed into the vector-vector elementwise multiplication does not belong to [symbol] , the output coefficient of this index may take a default value, e.g. 0.

All the embodiments 1-5 and their variants may be combined with the embodiment 6. Instead of being built to be fed with the “maximum template”, the template-based tool may be built to be fed with an “enlarged maximum template”, i.e. the template with each dimension being larger than the maximum corresponding dimension over the block sizes in [symbol] . The embodiment disclosed for an operation of vector-vector elementwise product may also apply to other types of operations, e.g. vector-matrix product.

### Embodiment 7

Inside the template-based video coding tool, the operation of interest fed with information for identifying which decoded pixels are unavailable may need to reinterpret this information. This reinterpretation may depend on how the template is processed before being fed into this operation.

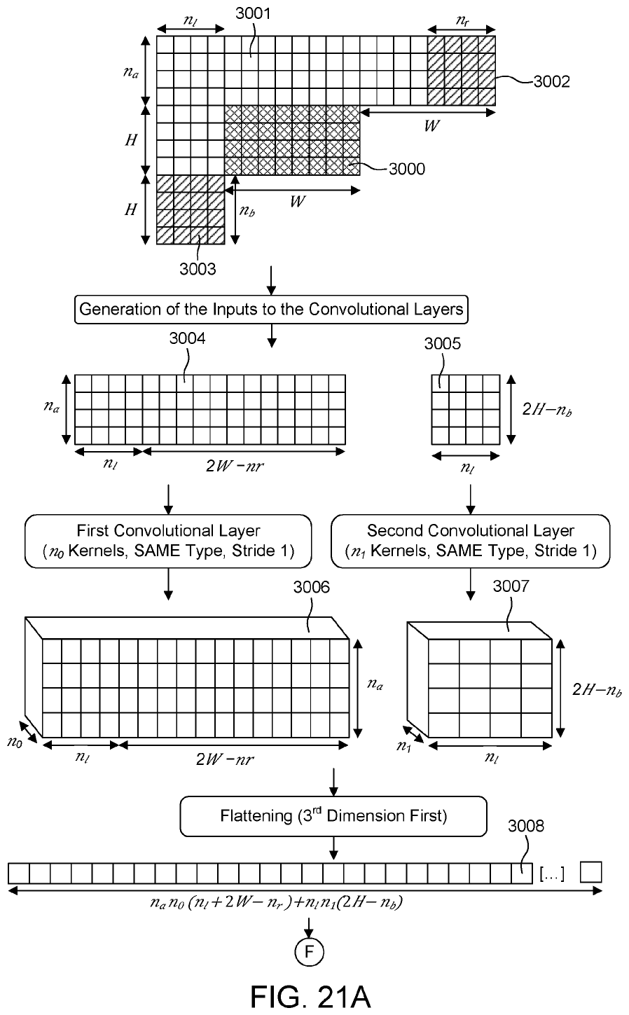

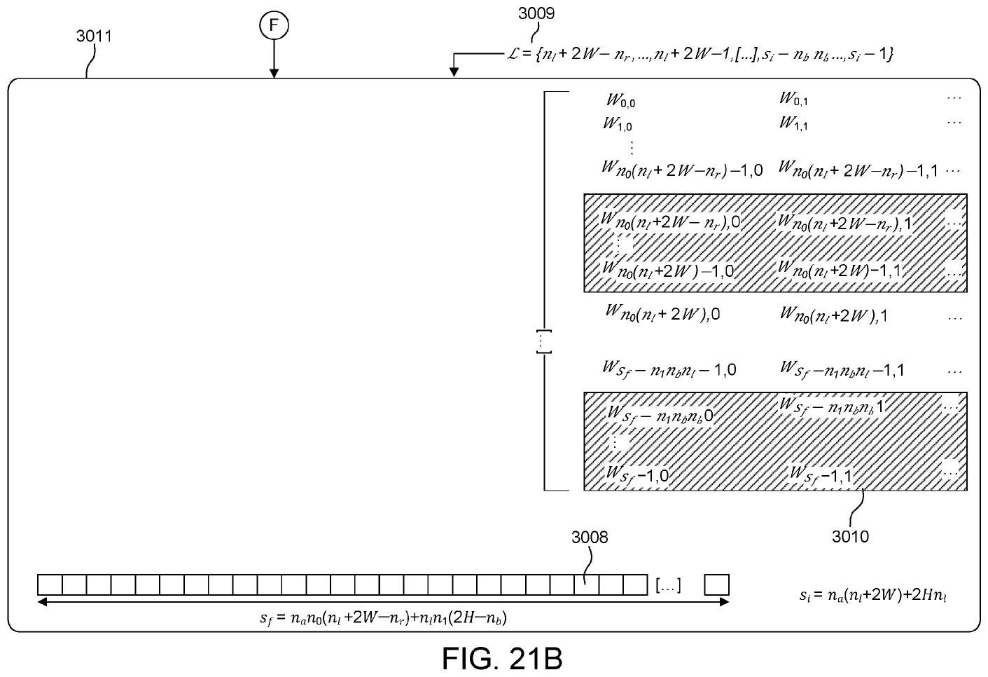

To illustrate this, FIGS. 21A-21B show an adaptation of the example of FIGS. 13A and 13B in the case where the template-based tool is a template-based neural network made of two convolutional layers and a fully-connected layer. The convolutional stride of the two layers is equal to 1 and the type of the two convolution is SAME. In this embodiment, the operation under consideration in the template-based tool is a vector-matrix product inside the fully-connected layer. The template (3001) of a given W×H block (3000) contains n_{b} ∈[|0, H|] rows (3003) of unavailable decoded pixels at its bottom and nᵣ ∈[|0,W|] columns (3002) of unavailable decoded pixels on its right side. (3002) and (3003) are removed from the template (3001) and (3001) is split into two portions (3004) and (3005). A first convolutional layer with stride 1, SAME type, and n₀ kernels take (3004) to generate the three-dimensional stack (3006). A second convolutional layer with stride 1, SAME type, and n₁ kernels take (3005) to produce the three-dimensional stack (3007). The SAME type means that the input to the convolutional layer is padded such that each of the two spatial dimensions of the output is equal to its corresponding dimension in the input divided by the stride. Then, (3006) and (3007) are flattened into a single vector (3008). For this flattening, the priority is given to the third dimension, then the second dimension. (3008) is fed into the fully-connected layer of the neural network. As shown in FIG. 21B, in the set [symbol] (3009), each index of unavailable decoded pixel inside the flattened template must be reinterpreted to incorporate the fact that the template (3001) has been processed (removal of unavailable portions and application of convolutions). For instance, the index nₗ+2 W−nᵣ becomes n₀(nₗ+2 W−nᵣ). As another example, the index nₗ+2 W−1 becomes n₀(nₗ+2 W)−1. In FIGS. 21A-21B, the computation skips amount to removing the rows in the weight matrix (3010) having indices in [symbol] following the reinterpretation.

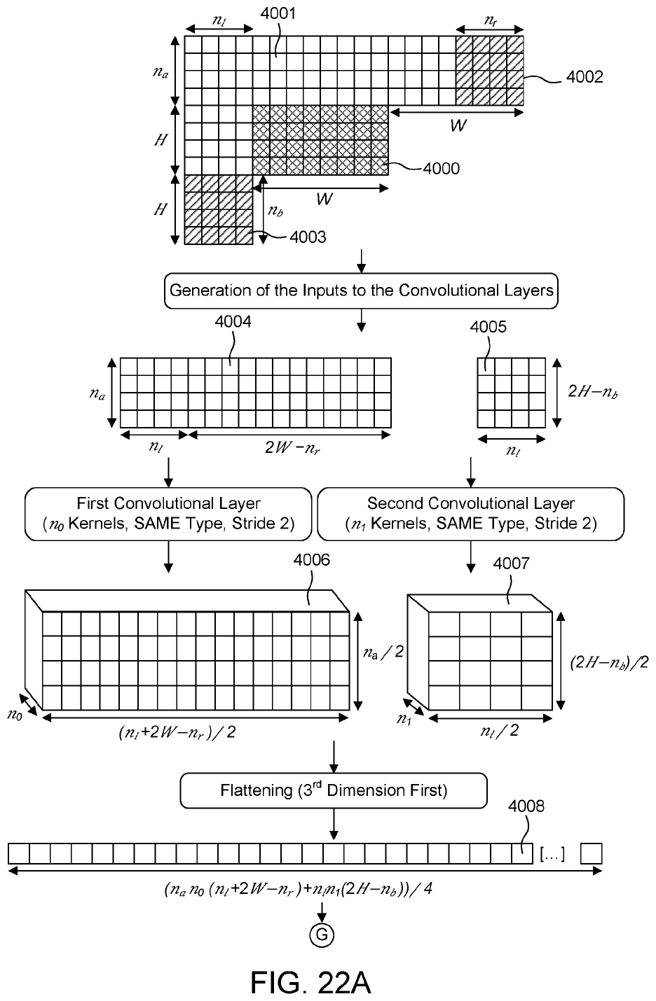

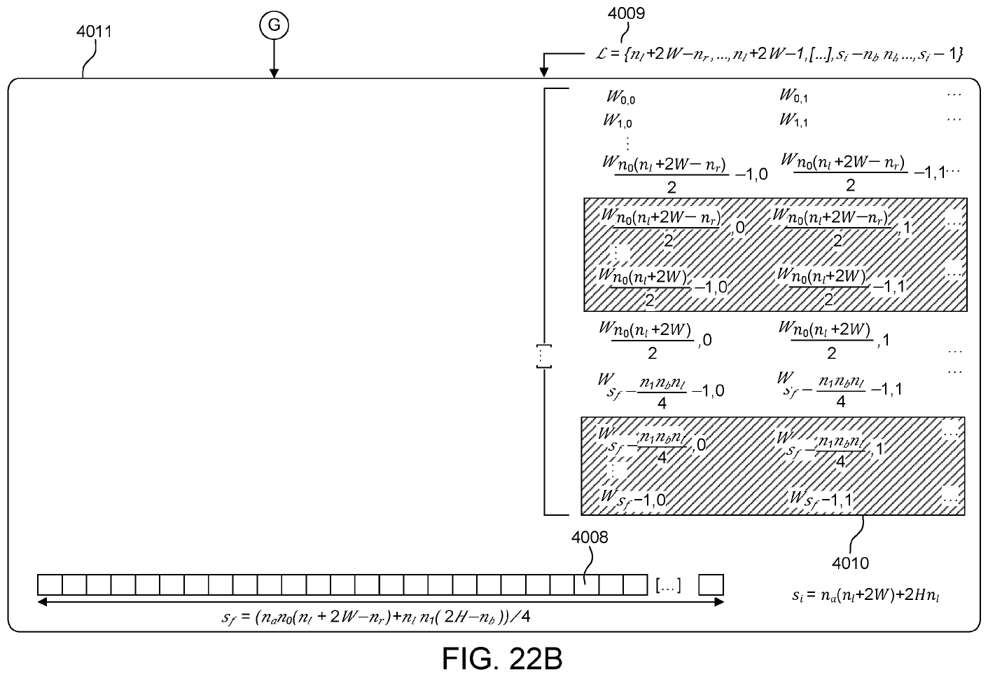

As another example, FIGS. 22A-22B display the same case as FIGS. 21A-21B, but using convolutional strides 2 instead of 1. In FIGS. 22A-22B, [symbol] is unchanged. However, the reinterpretation of each index in [symbol] is adapted as the processing of the template before being fed into the vector-matrix product in the neural network changes.

In the templates (3001) and (4001), the light gray squares indicate unavailable decoded pixels. In the weight matrices (3010) and (4010), the light gray areas contain the weights that are unused because of computation skips.

In all the previously disclosed embodiments, the template is extended towards the above-right side of the block by W additional columns of decoded pixels and towards the bottom-left side of the block by H additional rows of decoded pixels. These embodiments are however not limited to these extensions and may also be generalized to different extensions, i.e. different sizes and different forms.

### Embodiment 8

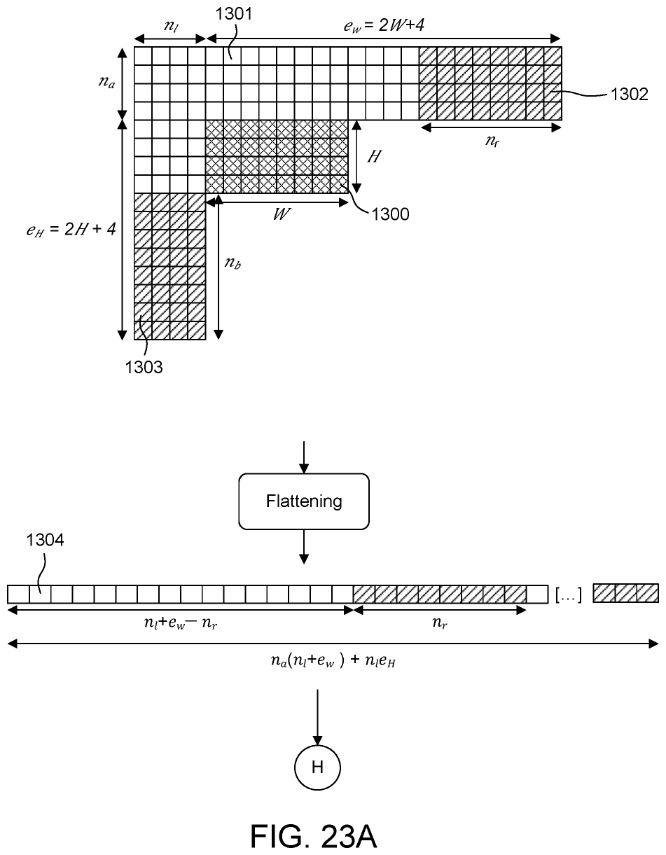

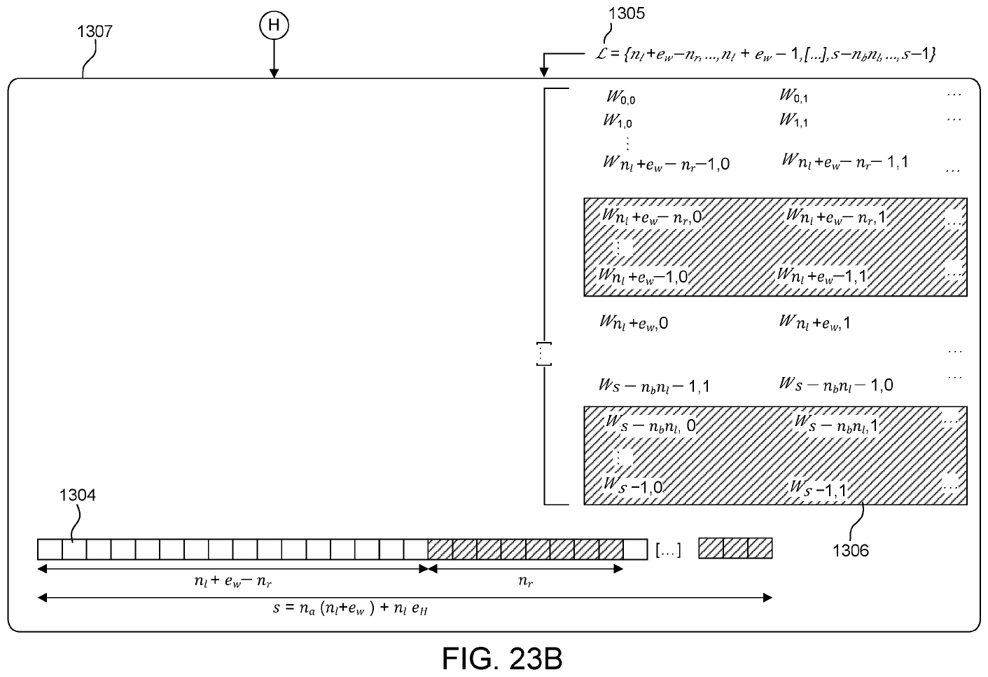

As an example, FIGS. 23A-23B shows an adaptation of the example of FIGS. 13A and 13B with e_{w}=2 W+4 and e_{H}=2H+4. The template (1301) of a given W×H block (1300) contains n_{b} ∈[|0, e_{H}−H|] rows (1303) of unavailable decoded pixels at its bottom and nᵣ ∈[|0, e_{w}−W|] columns (1302) of unavailable decoded pixels on its right side. The template is first flattened, yielding (1304). Then, the product (1307) between the flattened template (1304) and weight matrix (1306) uses the set [symbol] of indices of unavailable decoded pixels (1305) inside the flattened template to skip multiplications et additions.

In all the previously disclosed embodiments, the template extended towards the above-right side of the block to be encoded can cover as many available decoded pixels as possible, in the limit of W additional columns of decoded pixels. The extension towards the bottom-left side of this block can cover as many available decoded pixels as possible, in the limit of H additional rows of decoded pixels. In other embodiments, there is no limit on the extensions. Finally, extended templates of various forms are proposed, e.g. template completely surrounding the current block.

In all the previously disclosed embodiments, the template is extended towards the above-right side of the block and towards the bottom-left side of the block. These embodiments are however not limited to these extensions.

### Embodiment 9

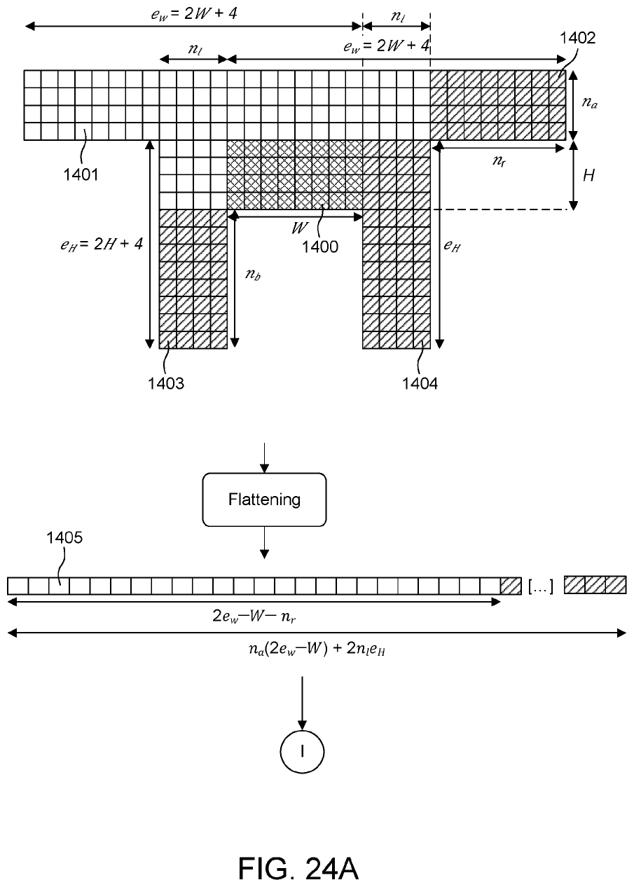

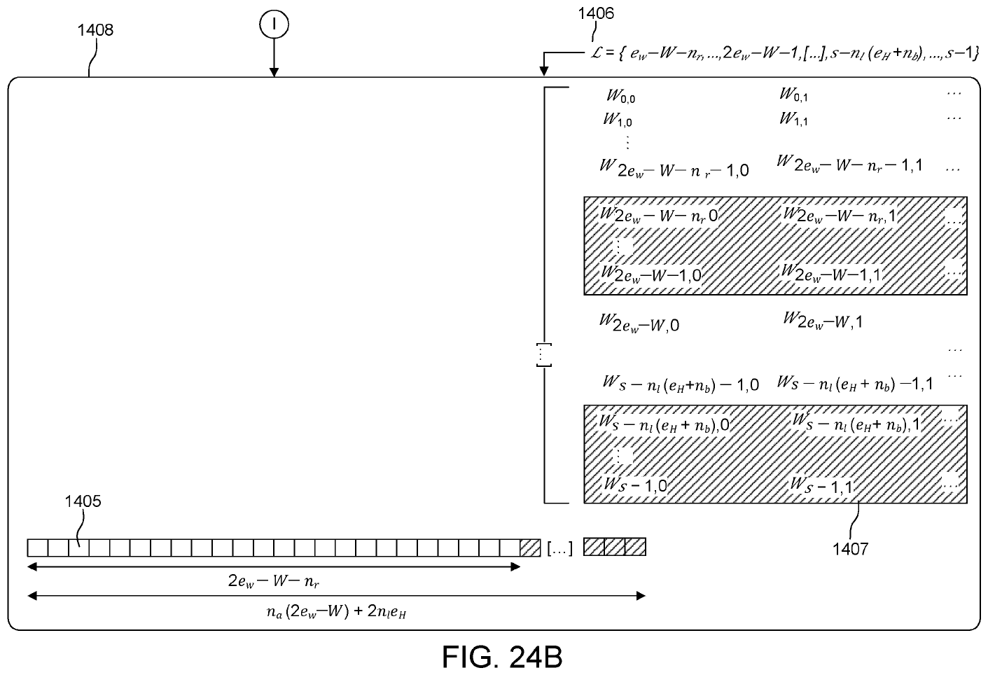

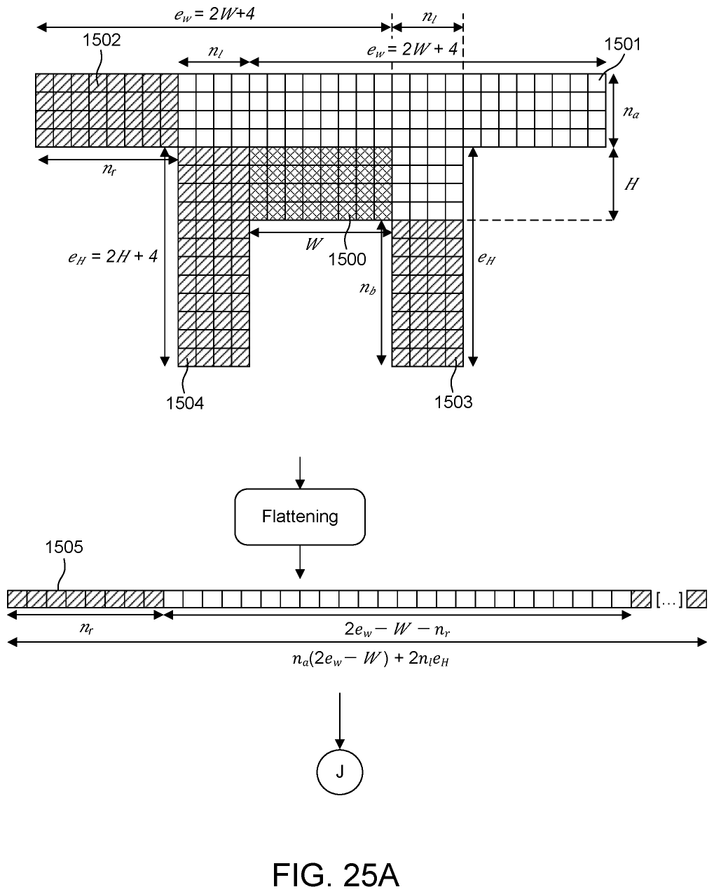

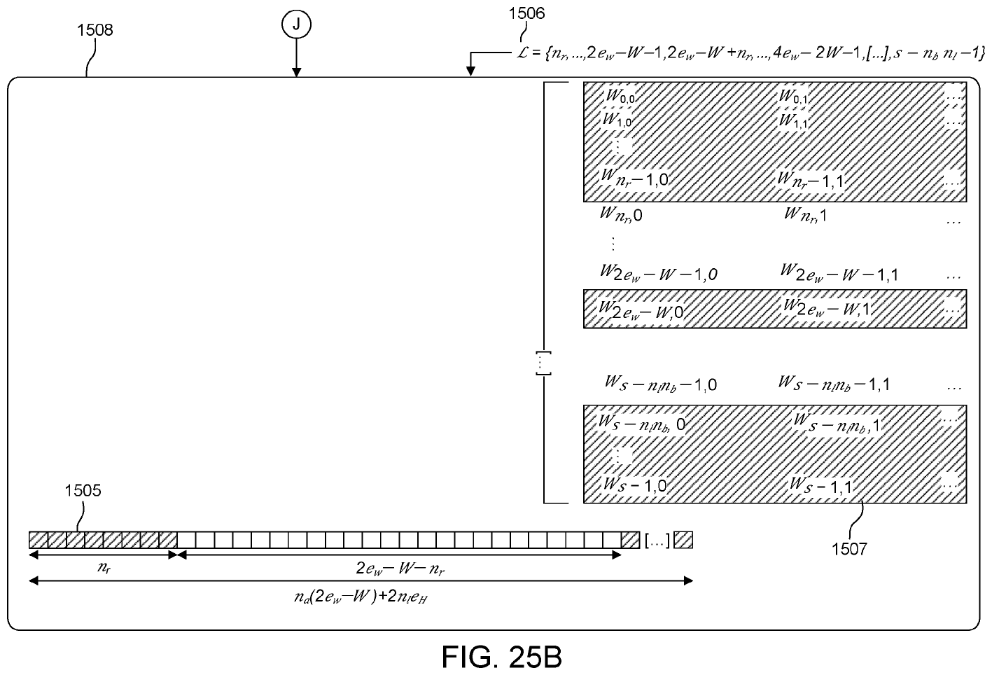

As an example, FIGS. 24A-24B and 25A-25B show an adaptation of the example in FIGS. 13A and 13B with a template that is further extended to the above-left side of the block and towards the bottom-right side of the block. This form of extended template may be advantageously used with a different encoding order than the classical encoding/decoding order, i.e. from left to right and top to bottom, e.g. the fixed encoding/decoding order of VVC and ECM. The encoding/decoding order can thus be switched horizontally, from left to right or right to left, at a given macroblock level. However, it should be understood that this type of template may also be used with a classical left to right and top to bottom encoding/decoding order.

A first example using such an extended template is depicted on FIGS. 24A-24B. FIG. 24A shows an extended template (1401) comprising lines of pixels above the current block W×H block (1400) and further columns of pixels on both left and right side of the block (1400). More precisely, on FIG. 24A, the extended template comprises a (2e_{w}−W)×nₐ block on top of the current block (1400) and two nₗ×e_{H} blocks on the right and left side respectively. In an example, e_{w}=2 W+4 and e_{H}=2H+4. However, different values may be used. The template (1401) of a given W×H block (1400) contains n_{b} ∈[|0, e_{H}−H|] rows (1403) of unavailable decoded pixels at its bottom and nᵣ ∈[|0, e_{w}−W|] columns (1402) of unavailable decoded pixels on its right side. With an encoding/decoding order being from left-to-right, the e_{H}nₗ decoded pixels at (1404) are always unavailable. The template is first flattened, yielding (1405). Note that the rectangle of height e_{H} and width nₗ on the right side of the block (1400) is flattened at last. Then, the product (1408) between the flattened template (1405) and weight matrix (1407) uses the set [symbol] of indices of unavailable decoded pixels (1406) inside the flattened template to skip multiplications et additions.

Another example using such an extended template is depicted on FIGS. 25A-25B. FIG. 25A shows an extended template (1501) comprising lines of pixels above the current block W×H block (1500) and further columns of pixels on both left and right side of the block (1500). More precisely, on FIG. 25A, the extended template comprises a (2e_{w}−W)×nₐ block on top of the current block (1500) and two nₗ×e_{H} blocks on the right and left side respectively. In this example, e_{w}=2 W+4 and e_{H}=2H+4. The template (1501) of a given W×H block (1500) contains n_{b} ∈[|0, e_{H}−H|] rows (1503) of unavailable decoded pixels at its bottom and nᵣ ∈[|0, e_{w}−W|] columns (1502) of unavailable decoded pixels on its left side. With the encoding/decoding order being from right-to-left, the e_{H}nₗ decoded pixels at (1504) are always unavailable. The template is first flattened, yielding (1505). Again, the rectangle of height e_{H} and width nₗ on the right side of the block (1500) is flattened at last. Then, the product (1508) between the flattened template (1505) and weight matrix (1507) uses the set [symbol] of indices of unavailable decoded pixels (1506) inside the flattened template to skip multiplications et additions.

### Embodiment 10

The specificity of an inter slice is that it contains CUs predicted in intra and CUs predicted in inter. The decoding of a given CTU in an inter slice is decomposed into three steps. In the first step, called parsing, all the bits of syntax associated to this CTU are read from the bitstream. In the second step, called decoding, these bits are interpreted. For instance, the bits associated to the prediction of a given CU are interpreted as intra/inter mode. In the third step, the pixels of the CTU are reconstructed. For a CU predicted in inter, the prediction only needs decoded pixels from already decoded reference frames. In contrast, for a CU predicted in intra, the prediction only needs decoded pixels located above and on the left side of the current CU. That is why, in a given CTU in an inter slice, for all the CUs predicted in inter, the third steps can be run in parallel. However, for any CU predicted in intra, the third step must be run after reconstructing the pixels in the CUs located above it and on its left side. Knowing that, in some decoders, for a given CTU in an inter slice, for all the CUs predicted in inter, the third steps are parallelized. Then, at a given timestep during the third steps for the CUs predicted in inter, the third step for a CU predicted in intra can start. For simplicity, let us say that, for a given CTU in an inter slice, the timestep for beginning the third step for a CU predicted in intra comes after completing the third steps for all the CUs predicted in inter. Then, for a CU predicted in intra, the prediction may access more decoded pixels than those located above the CU and on its left side.

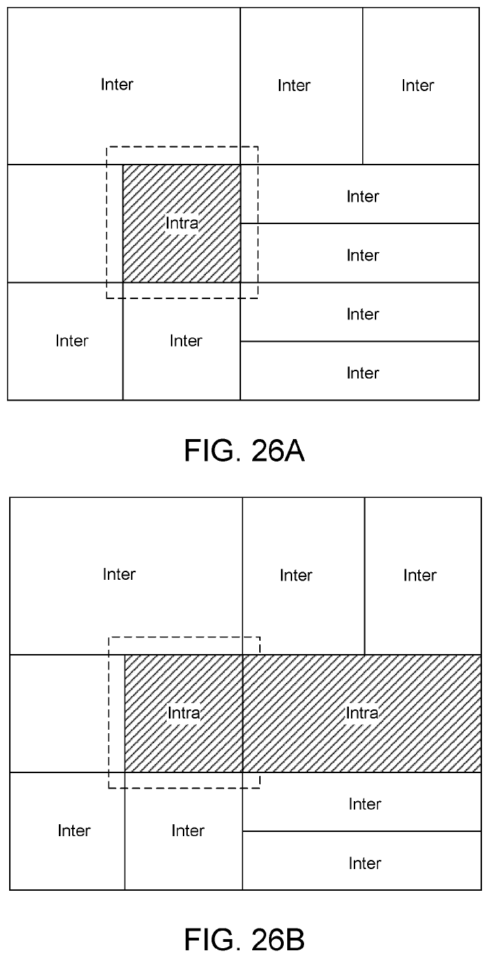

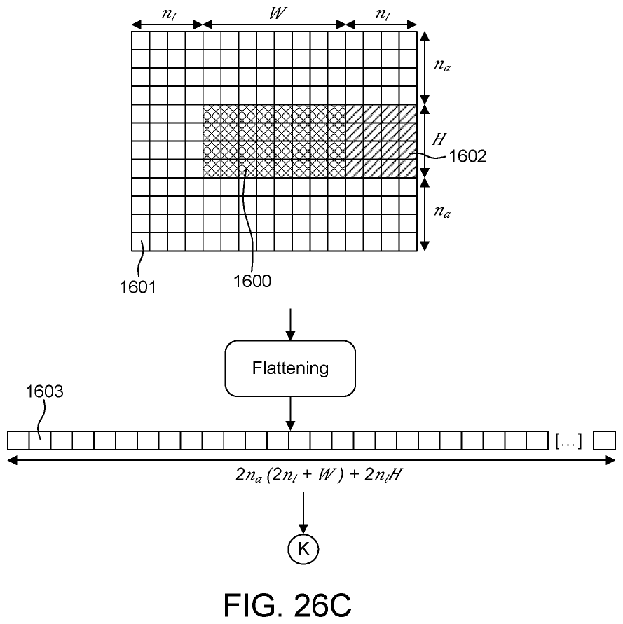

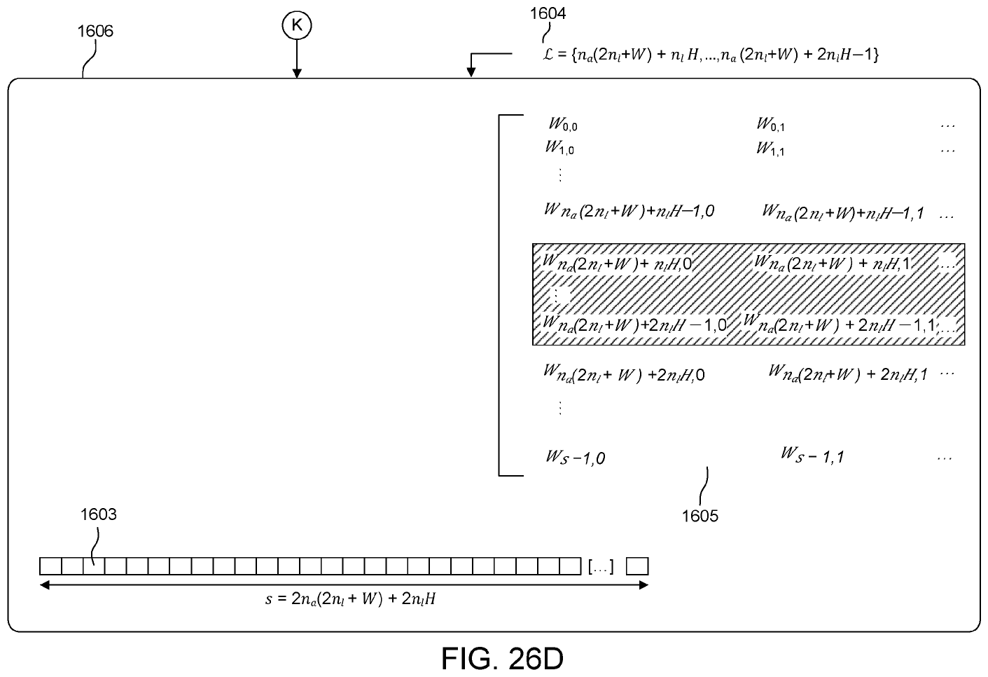

For instance, on the decoder side, in the CTU in the inter slice shown in FIG. 26A, for the CU predicted in intra (displayed in hatched), the prediction may access decoded pixels located all around this CU. For the current CTU in the current inter slice, the timestep for beginning the reconstruction of the pixels of a CU predicted in intra occurs after completing the reconstruction of the pixels of all the CUs predicted in inter. The dashed line thus delineates the decoded pixels that may be accessed by the prediction module for the CU predicted in intra. As another example, on the decoder side, in the CTU in the inter slice shown in FIG. 26B, for the leftmost CU predicted in intra, the prediction may access decoded pixels located above/below it and on its left side. For the leftmost CU predicted in intra, the dashed line delineates the decoded pixels that may be accessed by its prediction module.

In an inter slice, given the above-mentioned decoder implementation, the previously disclosed embodiments may be advantageously used with a template-based tool specific to the template of a block predicted in intra.

For instance, FIGS. 26C and 26D depict an adaptation of the example in FIGS. 13A and 13B when the template-based tool is fed with the template of a block predicted in intra inside an inter slice, the operation of interest in the template-based tool is a vector-matrix product, and the input template is first flattened. Besides, FIGS. 26C and 26D show an extended template (1601) comprising pixels all around the current block W×H block (1600). More precisely, on FIGS. 26C and 26D, the extended template comprises a (W+2*nₗ)×nₐ block on top of the current block (1600), a (W+2*nₗ)×nₐ block below the current block (1600) and two nₗ×H blocks on the right and left sides respectively. Different values may be used for the height and width of the blocks surrounding the current block (1600).

In the template (1601) of the W×H block (1600) predicted in intra, e.g. the leftmost CU predicted in intra in FIG. 26B, all decoded pixels on the right side of the block (1602) are unavailable. The template is first flattened, yielding (1603). Then, the product (1606) between the flattened template (1603) and weight matrix (1605) uses the set [symbol] of indices of unavailable decoded pixels (1604) inside the flattened template to skip multiplications et additions. In the template (1601), the light gray squares indicate unavailable decoded pixels. In the weight matrix (1605), the light gray areas contain the weights that are unused because of computation skips.

In the various embodiments, the operation whose some parts/computations are skipped is a vector-matrix product. This is only an example. In all the various embodiments other operation may be considered for computation skip such as elementwise vector-vector product, matrix product of tensors, e.g. as implemented by “tf.matmul” in Tensorflow or “torch.matmul” in PyTorch, outer product between two vectors, e.g. as implemented by “numpy.outer” in Numpy. TensorFlow, PyTorch and Numpy are libraries.

Various methods and other aspects described in this application can be used to modify modules, for example, the intra prediction modules (260, 360), of a video encoder 200 and decoder 300 as shown in FIG. 2 and FIG. 3. Moreover, the present aspects are not limited to ECM, VVC or HEVC, and can be applied, for example, to other standards and recommendations, and extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, decode re-sampling filter coefficients, re-sampling a decoded picture; or for example, obtaining information for identifying which pixels are unavailable inside a template of a current block of a picture; applying a template-based tool using the obtained information to determine information to be used for decoding the current block; decoding said current block using said determined information.

As further examples, in one embodiment “decoding” refers only to entropy decoding, in another embodiment “decoding” refers only to differential decoding, and in another embodiment “decoding” refers to a combination of entropy decoding and differential decoding, and in another embodiment “decoding” refers to the whole reconstructing picture process including entropy decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, determining re-sampling filter coefficients, re-sampling a decoded picture, or for example, obtaining information for identifying which pixels are unavailable inside a template of a current block of a picture; applying a template-based tool using the obtained information to determine information to be used for encoding the current block; encoding said current block using said determined information.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

This disclosure has described various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message. Other manners are also available, including for example manners common for system level or application level standards such as putting the information into one or more of the following:

a. SDP (session description protocol), a format for describing multimedia communication sessions for the purposes of session announcement and session invitation, for example as described in RFCs and used in conjunction with RTP (Real-time Transport Protocol) transmission.
b. DASH MPD (Media Presentation Description) Descriptors, for example as used in DASH and transmitted over HTTP, a Descriptor is associated to a Representation or collection of Representations to provide additional characteristic to the content Representation.
c. RTP header extensions, for example as used during RTP streaming.
d. ISO Base Media File Format, for example as used in OMAF and using boxes which are object-oriented building blocks defined by a unique type identifier and length also known as ‘atoms’ in some specifications.
e. HLS (HTTP live Streaming) manifest transmitted over HTTP. A manifest can be associated, for example, to a version or collection of versions of a content to provide characteristics of the version or collection of versions.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Some embodiments may refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of re-sampling filter coefficients or an encoded block. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

A number of embodiments has been described above. Features of these embodiments can be provided alone or in any combination, across various claim categories and types.

1. A decoding method comprising:
obtaining information identifying which pixels are unavailable inside a template of a current block of a picture;
applying a template-based tool using the information identifying unavailable pixels to determine information to be used for decoding the current block, wherein applying a template-based tool using the obtained information comprises skipping a computation in a case where the computation involves a pixel identified as unavailable by the obtained information; and
decoding the current block using the determined information.

2. (canceled)

3. The method according to claim 1, further comprises flattening the template prior to applying the template-based tool.

4. The method according to claim 1, wherein obtaining information for identifying which pixels are unavailable inside a template of a current block comprises obtaining indices of all pixels which are unavailable.

5. The method according to claim 1, wherein obtaining information for identifying which pixels are unavailable inside a template of a current block comprises obtaining indices of all pixels which are available.

6. The method according to claim 1, wherein obtaining information for identifying which pixels are unavailable inside a template of a current block comprises obtaining flags, each flag indicating for a pixel in the template whether the pixel is available or not.

7. The method according to claim 1, wherein obtaining information for identifying which pixels are unavailable inside a template of a current block comprises for a group of neighboring unavailable pixels, obtaining an index of a first unavailable pixel and an index of a last unavailable pixel in the group.

8. The method according to claim 1, wherein obtaining information for identifying which pixels are unavailable inside a template of a current block comprises for a group of neighboring available pixels, obtaining an index of a first available pixel and an index of a last available pixel in the group.

9. The method according to claim 1, further comprising spatially reorganizing pixels inside the template in order to increase a number of memory-contiguous available pixels.

10. The method according to claim 1, wherein an unavailable pixel is one of a pixel not reconstructed yet, a pixel belonging to a tile different from a tile to which the current block belongs or a pixel outside of picture boundaries.

11-13. (canceled)

14. An encoding method comprising:
obtaining information identifying which pixels are unavailable inside a template of a current block of a picture;
applying a template-based tool using the information identifying unavailable pixels to determine information to be used for encoding the current block, wherein applying a template-based tool using the obtained information comprises skipping a computation in a case where the computation involves a pixel identified as unavailable by the obtained information; and
encoding the current block using the determined information.

15. (canceled)

16. The method according to claim 14, further comprises flattening the template prior to applying the template-based tool.

17. The method according to claim 14, wherein obtaining information for identifying which pixels are unavailable inside a template of a current block comprises obtaining indices of all pixels which are unavailable.

18. The method according to claim 14, wherein obtaining information for identifying which pixels are unavailable inside a template of a current block comprises obtaining indices of all pixels which are available.

19. The method according to claim 10, wherein obtaining information for identifying which pixels are unavailable inside a template of a current block comprises obtaining flags, each flag indicating for a pixel in the template whether the pixel is available or not.

20. The method according to claim 14, wherein obtaining information for identifying which pixels are unavailable inside a template of a current block comprises for a group of neighboring unavailable pixels, obtaining an index of a first unavailable pixel and an index of a last unavailable pixel in the group.

21. The method according to claim 14, wherein obtaining information for identifying which pixels are unavailable inside a template of a current block comprises for a group of neighboring available pixels, obtaining an index of a first available pixel and an index of a last available pixel in the group.

22. The method according to claim 14, further comprising spatially reorganizing pixels inside the template in order to increase a number of memory-contiguous available pixels.

23. The method according to claim 14, wherein an unavailable pixel is one of a pixel not reconstructed yet, a pixel belonging to a tile different from a tile to which the current block belongs or a pixel outside of picture boundaries.

24-26. (canceled)

27. A decoding apparatus comprising one or more processors and at least one memory coupled to the one or more processors, wherein the one or more processors are configured to perform:
obtaining information identifying which pixels are unavailable inside a template of a current block of a picture;
applying a template-based tool using the information identifying unavailable pixels to determine information to be used for decoding the current block, wherein applying a template-based tool using the obtained information comprises skipping a computation in the case where the computation involves a pixel identified as unavailable by the obtained information; and
decoding the current block using the determined information.

28. An encoding apparatus comprising one or more processors and at least one memory coupled to the one or more processors, wherein the one or more processors are configured to perform:
obtaining information identifying which pixels are unavailable inside a template of a current block of a picture;
applying a template-based tool using the information identifying unavailable pixels to determine information to be used for encoding the current block, wherein applying a template-based tool using the obtained information comprises skipping a computation in the case where the computation involves a pixel identified as unavailable by the obtained information; and
encoding the current block using the determined information.

29-30. (canceled)
